(19) United States
(12) Patent Application Publication
(10) Pub. No.: US 2008/0221275 A1
(43) Pub. Date: Sep. 11, 2008

(54) Ethylene/dicyclopentadiene/norbornene terpolymer materials having desirable structural and thermal properties

(76) Inventors: Lisa S. Baugh, Ringoes, NJ (US); Enock Berluche, Phillipsburg, NJ (US); Abhimanyu O. Patil, Westfield, NJ (US); Beverly J. Poole, Houston, TX (US); Kevin D. Robinson, Houston, TX (US); Kevin R. Squire, Kingwood, TX (US)

Correspondence Address: ExxonMobil Research and Engineering Company, P.O. Box 900, Annandale, NJ, 08801-0900, US

(21) Appl. No.: 12/074,213

(22) Filed: Feb. 29, 2008

Related U.S. Application Data
(63) Continuation-in-part of application No. 11/606,738, filed on Nov. 30, 2006.
(60) Provisional application No. 60/906,615, filed on Mar. 13, 2007.

(51) Int. Cl. C08F 4/76; C08F 36/00; C08F 36/04; C08F 4/80

(52) U.S. Cl. 525/332.1; 526/283; 526/170; 526/171

(57) ABSTRACT

Provided are selected types of terpolymer components comprising terpolymers having monomer units derived from ethylene (E), dicyclopentadiene (DCPD) and norbornene-based (NB) co-monomers. Such terpolymer components have certain specified amounts of each co-monomer as well as certain specified molecular weight and glass transition temperature characteristics. Terpolymer components which are derivatized by hydrogenation and/or by epoxidation and/or hydroxylation are also disclosed, as well as thermoplastic polyolefin compositions which contain the terpolymer components and which have especially desirable structural and thermal properties.

Also provided are processes for preparing and derivatizing the terpolymer components herein. Such preparation processes comprise: a) contacting ethylene with a polymerization mixture comprising selected amounts of both DCPD and NB co-monomers, in the presence of a selected activated cyclopentadienyl-fluorenyl metallocene catalyst under specific polymerization conditions to thereby form the desired ethylene-dicyclopentadiene-norbornene terpolymer components within the polymerization mixture. These terpolymer components can then be subsequently derivatized by hydrogenation or functionalization of the residual double bonds therein.

This application claims the benefit of U.S. Provisional Application No. 60/906,615 filed Mar. 13, 2007 and is a Continuation-in-Part of U.S. application Ser. No. 11/606,738 filed Nov. 30, 2006.

### FIELD

This disclosure relates to preparation of certain terpolymers of ethylene (E) and two different types of cyclic olefins which are those based on dicyclopentadiene (DCPD) and those based on norbornene (NB). Such terpolymers can be functionalized or hydrogenated and used as structural polyolefins or in structural polyolefin compositions.

### BACKGROUND

Identification of polyolefin-based materials which function equivalently to conventional engineering thermoplastics (ETPs) for structural applications, particularly as automotive materials, would be commercially and economically advantageous. Polyolefins possessing the necessary properties to function as ETPs could compete against existing ETP materials (polycarbonates, polyurethanes, styrene-acrylonitrile and styrene-acrylonitrile-butadiene copolymers, etc.) in terms of price vs. performance. The development of such “structural polyolefins” (SPOs) would thus be highly desirable.

Ethylene-dicyclopentadiene copolymers (E-DCPDs) are attractive as a potential basis for development of SPOs. It is possible to tailor the properties of such copolymers by means of appropriate selection of polymerization catalysts. E-DCPD materials are typically amorphous materials possessing good optical properties and relatively high glass transition temperatures (T_{g}s). Many thermal and mechanical properties for neat E-DCPDs and other cyclic olefin copolymers (COCs) are competitive with those of commercial ETPs and polypropylene-based materials.

E-DCPD copolymers offer the unique advantage, as compared to COCs and polypropylene-based materials containing mono-olefinic co-monomers such as norbornene, of facile property adjustment, alteration and tailoring by means of post-polymerization chemical derivatization (hydrogenation, epoxidation or other functionalization, etc., with or without ring opening) of the pendant DCPD cyclopentenyl double bond which remains in the chemical structure after the copolymer is formed. Functionalization can be used to improve and tune resin properties such as compatibility with other polymers, paintability, adhesion, and filler interactions in compounding. E-DCPD copolymers are therefore attractive as potential novel ETPs for a number of reasons.

It is desirable for E-DCPD copolymers which are to ultimately be used to prepare structural polyolefins to have relatively high T_{g} values. The T_{g} of a polymeric material is the temperature below which the molecules in its amorphous phase have very little mobility. On a macroscopic scale, polymers are rigid below their glass transition temperature but can undergo plastic deformation above it. Thus, it is desirable for a material utilized for structural applications where dimensional heat stability is required to have a T_{g} sufficiently high to prevent plastic deformation at its use temperatures. For the SPO materials of interest herein, T_{g} values in the range of 120° C. to 180° C. are highly desirable.

It is also desirable that the T_{g} value of a polymer may be adjusted in a predictable fashion by varying the polymer's microstructural features, since the desirable end use temperature ranges of structural materials vary according to application. In general, higher T_{g}s desirably widen the end use temperature range of a material, but undesirably add cost to material processing. Facile adjustment of T_{g} allows for the selection of SPO materials exhibiting the best price versus performance balance for a particular end use application.

In addition to the proper selection of T_{g} and optimal control of T_{g} by microstructure and/or composition, the appropriateness of the use of a certain polymer as an SPO material relies on other properties which are independent of T_{g}; for example, molecular weight, thermal stability to chemical decomposition, and miscibility with desired tougheners, fillers, etc. In particular, polymers with high molecular weights are desirable as compared to polymers with lower molecular weights, since such materials exhibit greater melt strengths and therefore superior processing capabilities. It is generally desirable to synthesize polymers having the highest possible Weight Average Molecular Weight (M_{w}) and/or Number Average Molecular Weight (Mₙ) achievable at a given composition. It is particularly desirable to synthesize copolymers having M_{w}s of at least 175,000 g/mol, and/or having Mₙs of at least 75,000 g/mol (as measured versus polyethylene or polystyrene standards by Gel Permeation Chromatography (GPC) analysis.

Given the foregoing, copolymeric materials which comprise both ethylene and DCPD-based co-monomers and which are suitable for use as structural polyolefins will have a desirable combination of chemical, structural/mechanical and thermal characteristics. Such a combination of characteristics will generally need to be tailored to the desired end use to which the structural polyolefin will be put and to the conditions which will be encountered during that end use. Nevertheless, the most important characteristic of such structural polyolefins relates to the thermal behavior of such copolymeric materials as reflected in their glass transition temperature or T_{g}.

A wide variety of compositional and microstructural features may be used to influence the T_{g} of a polymer or copolymer. In general, the T_{g} values exhibited by E-DCPD copolymers increase as the DCPD content of the copolymer increases. Nevertheless, even for a copolymer with a given DCPD content, it may also be possible to further vary and control T_{g} by adjusting various other structural characteristics. Such features as the nature of co-monomer placement along the chain (sequence distribution and degree of random, alternating, or blocky character), tacticity, and stereoconfiguration characteristics of the co-monomer (for example, endo-versus exo-DCPD units), and the like, can result in higher or lower T_{g}s for copolymers of the same compositional makeup. These structural characteristics can, in turn, be adjusted or changed by means of selecting appropriate copolymer preparation procedures. Thus, such factors as polymerization reaction conditions and the nature of the polymerization catalyst used can all play a role in determining copolymer structure and the resulting T_{g} of such materials.

As indicated, the most straightforward compositional way of altering the T_{g} of amorphous E-DCPD copolymers is by varying the DCPD content of such copolymers. Also as noted hereinbefore, in general, the higher the DCPD content of the copolymer relative to the content of ethylene, the higher the T_{g}. However, as the DCPD content of E-DCPD copolymers increases, so also does the amount of residual unsaturation introduced within the copolymer. This renders the resulting copolymer more susceptible to unwanted cross-linking and other unwanted side reactions unless the copolymer is rendered more stable by derivatizing, e.g., by hydrogenating or by functionalizing, the residual unsaturation therein.

One way of decoupling the effects of increasing T_{g} and increasing copolymer residual unsaturation, as brought about as a consequence of increasing DCPD content, is to introduce into the copolymer a third co-monomer type. Such a third co-monomer type, the introduction of which forms a terpolymer, is ideally one which can also furnish desirably high T_{g} values for the resulting terpolymer but not introduce any additional residual unsaturation which could contribute to the instability of (and therefore the need to more thoroughly derivatize) the resulting terpolymer. One potential type of such a third co-monomer comprises cyclic mono-olefins such as norbornene, if such a cyclic mono-olefin can be suitably incorporated in appropriate amounts and using suitable copolymerization procedures to provide terpolymers such as poly(ethylene-co-dicyclopentadiene-co-norbornene) (E-DCPD-NB) terpolymers, of suitable molecular weight and thermal characteristics.

Copolymers comprising α-olefins, cyclic olefins and third co-monomer types are known in the art. For example, PCT Patent Application No. WO 2006/118261 discloses copolymers comprising structural units derived from α-olefin co-monomers such as ethylene, cycloolefin co-monomers, and polyene co-monomers which leave non-cyclic residual double bonds within the resulting copolymer structure. Copolymers formed from such co-monomers are said to be non-crystalline or low crystallinity materials having non-cyclic double bonds incorporated into the side chains thereof. It is noted that these side chain double bonds in such copolymers can be cross-linked and/or functionalized with polar groups.

Some terpolymers based on ethylene, DCPD and norbornene are known in the art. U.S. Pat. No. 6,627,714, for example, discloses the preparation of copolymers of ethylene and cyclic olefins using a very specifically defined and selected particular type of metallocene catalyst which is a cyclopentadienyl-tetramethylcyclopentadienyl zirconium complex with a methylene bridge between the cyclopentadienyl ligand fragments. Such copolymers comprise from 1 to 99 mol % of ethylene and a cycle diene such as DCPD or tricyclopentadiene in molar amounts of from 5% to 99%. These copolymers can also optionally comprise a third type of co-monomer which can be a cyclic olefin such as norbornene, and this cyclic olefin co-monomer can be present in molar amounts comprising up to 90% of the copolymer.

Example 7 in U.S. Pat. No. 6,627,714 demonstrates preparation of an E-DCPD-NB terpolymer comprising 25.7 mol % of DCPD and 41.3 mol % of norbornene. This terpolymer has a Weight Average Molecular Weight, M_{w}, of 182,000 and a polydispersity, M_{w}/Mₙ of 3.5. There is no disclosure in this example of any thermal properties of the terpolymer which is prepared.

Japanese Patent Application No. JP 05-26823 also discloses preparation of copolymers of α-olefins such as ethylene (80-99.9 mol %) with cyclic dienes such as DCPD (0.1-20 mol %). These materials too can optionally contain cyclic mono-olefins such as norbornene (up to 19.9 mol %) and can have T_{g}s up to 30 C. The copolymers of this type are prepared using zirconium-bridged bis(cyclopentadienyl) metallocene catalysts. The one specific example (Example 4) of an E-DCPD-NB terpolymer in this document contains 1.0 mol % DCPD and 6.3 mol % NB. This Example 4 terpolymer is reported to have a T_{g} of 4° C. and a melting temperature (Tₘ) of 79° C.

U.S. Pat. No. 5,837,787 discloses rubbery amorphous cyclic olefin/α-olefin copolymers having cyclic olefin co-monomer contents ranging from 5% to 30%. The preferred α-olefin is ethylene, and the preferred cyclic olefin is norbornene. Relatively minor proportions (0.5 to 3 mol %) of polyenes such as DCPD can also be incorporated into these copolymers although no E-DCPD-NB terpolymers are specifically disclosed. These rubbery elastic copolymers of α-olefins and cyclic olefins of U.S. Pat. No. 5,837,787 are said to have a T_{g} between −50° C. and 50° C. and a Weight Average Molecular Weight of from 30,000 to 1,000,000 or more.

As indicated hereinbefore, it would also be desirable to provide hydrogenated or functionalized derivatives of such selected E-DCPD-NB terpolymers which could be tailored to provide useful structural polyolefins. Derivatization of E-DCPD-NB terpolymers can improve their stability and processability. Functionalization of these terpolymers can also improve other desirable properties, such as compatibility with other polymers, adhesion to fillers, and dyeability, which might be encountered during their preparation and/or use. Like E-DCPD-NB terpolymers themselves, hydrogenated or functionalized counterparts of these materials are, in general, also known in the art.

Japanese Patent Application No. JP 06-271617, for example, discloses hydrogenation of copolymers of α-olefins such as ethylene (80-99.9 mol %) with cyclic olefins (0.1-20 mol %). The cyclic olefins utilized can include combinations of both cyclic dienes like DCPD and cyclic mono-olefins like norbornene, to thereby form terpolymers. Such terpolymers have T_{g}s of less than 50° C. The hydrogenated derivatives of such terpolymers are said to have T_{g}s of less than 30° C. One specific example (Example 4) shows hydrogenation (95%) of an E-DCPD-NB terpolymer containing 1.0 mol % DCPD and 6.3 mol % norbornene.

As an alternative or complement to hydrogenation, it would also be desirable to carry out functionalization of such terpolymers to improve and tune resin properties such as compatibility with other polymers, paintability, adhesion, and filler interactions in compounding. One of the most common types of functionalized terpolymer materials prepared from precursor terpolymers containing co-monomers with unsaturation comprises materials prepared by epoxidation of the double bond within such unsaturated co-monomers. As with hydrogenated terpolymers, preferred functionalized, e.g., epoxidized, terpolymers would also be those that possess T_{g}s and molecular weights (M_{w}s and/or Mₙs) in the most useful range for structural applications.

Epoxidation of E-DCPD-NB terpolymers can provide improvement of a number of useful properties of these materials. Unfortunately, however, epoxidation of an E-DCPD-NB terpolymer copolymer can also raise its T_{g} significantly in comparison with the T_{g} of the non-functionalized copolymer precursor. It is, of course, desirable that T_{g} values of such materials, while being sufficiently high for structural uses, are not needlessly high. Melt-processing and -blending techniques used to manipulate polymers and to fabricate molded articles, such as injection molding and extrusion, require heating of a polymer above its T_{g} (in the case of an amorphous material) to allow the polymer to flow. At higher T_{g} values for a generally amorphous polymer, higher processing temperatures are required, resulting in a greater use of energy and higher processing costs and also resulting in a greater risk of thermal decomposition of the polymer. It is therefore desirable to prepare polymers with T_{g} values that are sufficiently high to permit dimensional stability over a desired temperature use range for a given structural application, yet remain low enough over the minimum required value that processing may be carried out at the lowest possible temperature.

When norbornene is introduced in appropriate amounts into the polymer as a third co-monomer type, it becomes possible to realize SPOs in the form of terpolymers which comprise enough DCPD-derived co-monomers for acceptable functionalization but which do not exhibit the undesirably excessive rise in T_{g} which, for example, epoxidation and or hydroxylation of E-DCPD copolymers can cause. For the functionalized SPO materials of interest herein, T_{g} values in the range of 135° C. to 180° C. are highly desirable.

Given all of the foregoing considerations, as well as the types of E-DCPD-NB terpolymers which are already known in the art, it would be desirable to identify additional terpolymer materials of this type which are especially useful as structural polyolefins, as well as preferred preparation procedures for making such materials. Such identification would provide terpolymers comprising ethylene, DCPD and norbornene-based co-monomers and having ideal thermal, Theological, compositional and stability characteristics to permit economic utilization of such materials to realize engineering thermoplastics. Such E-DCPD-NB materials are those which have sufficiently high molecular weights and the optimal and cost effective balance between DCPD content, norbornene content and appropriate T_{g} values. Such E-DCPD-NB materials would also be those which are suitable for desirable derivatization, for example, by hydrogenation or by functionalization such as epoxidation and/or hydroxylation.

### SUMMARY

In one aspect, the present disclosure is directed to terpolymer components which are useful for subsequent derivatization and incorporation into thermoplastic polyolefin compositions. Such terpolymer components comprise polymeric materials obtained by polymerizing ethylene, dicyclopentadiene (DCPD) and norbornene (NB) co-monomers. These terpolymer components: a) have a DCPD-derived co-monomer unit content of from 0.5 mol % to 64.5 mol %; b) have an NB-derived co-monomer unit content of from 0.5 mol % to 64.5 mol %; c) have a total dicyclopentadiene- and norbornene-derived co-monomer unit content of from 25 mol % to 65 mol %; d) have a Weight Average Molecular Weight, M_{w}, of greater than 100,000 g/mol and/or have a Number Average Molecular Weight, Mₙ, of greater than 30,000 g/mol as measured versus polyethylene or polystyrene standards by Gel Permeation Chromatography analysis; and e) comprise substantially amorphous material having a glass transition temperature, T_{g}, which ranges from 120° C. to 180° C.

In another aspect, the present disclosure is directed to hydrogenated or functionalized derivatives of the terpolymer components herein. Such hydrogenated or functionalized derivative components include those in which the E-DCPD-NB terpolymer components have been epoxidized and/or hydroxylated.

The hydrogenated terpolymer components herein are those wherein the terpolymers present in the components have been partially or completely hydrogenated. In such materials, the hydrogenated terpolymer components: a) have a DCPD-derived co-monomer unit content of from 0.5 mol % to 64.5 mol %; b) have an NB-derived co-monomer unit content of from 0.5 mol % to 64.5 mol %; c) have a total dicyclopentadiene- and norbornene-derived co-monomer unit content of from 25 mol % to 65 mol %; d) have a Weight Average Molecular Weight, M_{w}, of greater than 100,000 g/mol and/or have a Number Average Molecular Weight, Mₙ, of greater than 30,000 g/mol as measured versus polyethylene or polystyrene standards by Gel Permeation Chromatography analysis; and e) comprise substantially amorphous material having a glass transition temperature, T_{g}, which ranges from 120° C. to 165° C. In such components, the terpolymers have been hydrogenated such that from about 5% to 100% of the residual double bonds which were present in the terpolymers prior to hydrogenation have been saturated.

The epoxidized and/or hydroxylated terpolymer components herein are those wherein the terpolymers therein have been partially or completely functionalized at the residual double bonds of the terpolymers. In such materials, the terpolymer components: a) have a DCPD-derived co-monomer unit content of from 0.5 mol % to 64.5 mol %; b) have an NB-derived co-monomer unit content of from 0.5 mol % to 64.5 mol %; c) have a total dicyclopentadiene- and norbornene-derived co-monomer unit content of from 25 mol % to 65 mol %; d) have a Weight Average Molecular Weight, M_{w}, of greater than 100,000 g/mol and/or have a Number Average Molecular Weight, Mₙ, of greater than 30,000 g/mol as measured versus polyethylene or polystyrene standards by Gel Permeation Chromatography analysis; and e) comprise substantially amorphous material having a glass transition temperature, T_{g}, which ranges from about 130° C. to about 185° C. In such components, the terpolymers have been functionalized such that from about 50% to 100% of the residual double bonds which were present in the terpolymers prior to treatment with an oxidizing agent have been converted to oxirane rings or have been hydroxylated with hydroxyl groups to diol moieties.

In another aspect, the present disclosure is also directed to thermoplastic polyolefin compositions suitable for use in structural applications. Such polyolefin compositions comprise one or more derivatized terpolymer components such as the hydrogenated terpolymer components and/or the epoxidized and/or hydroxylated terpolymer components hereinbefore described.

In another aspect, the present disclosure is also directed to processes for preparing E-DCPD-NB terpolymer components and derivatives thereof. The process for preparing the underivatized terpolymer components herein comprises contacting ethylene with a polymerization mixture which has a dicyclopentadiene co-monomer molar concentration of from 0.25 molar to 7.4 molar and a norbornene co-monomer molar concentration of from 0.25 molar to 9.5 molar. Such contacting is carried out in the presence of a selected specific type of, generally activated, metallocene catalyst under polymerization conditions including a temperature of from 25° C. to 110° C. and an ethylene pressure of from 14.7 psig to 700 psig (101.4 kPa to 4826.3 kPa) for a period of time sufficient to form the E-DCPD-NB terpolymer materials within the polymerization mixture. The resulting E-DCPD-NB terpolymer materials can then be recovered from, or further reacted within, the polymerization mixture.

The type of metallocene catalyst used in the terpolymer component preparation process is one having the formula:

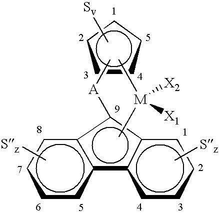

wherein M is a Group 3, 4, 5 or 6 transition metal atom, or a lanthanide metal atom, or actinide metal atom, A is bridging group, X₁ and X₂ are ligands associated with the metal M, and the S and S″ substituents are as hereinafter defined.

In yet another aspect, there are disclosed herein processes for preparing the hydrogenated and functionalized derivatives of the E-DCPD-NB terpolymer components as hereinbefore described. Hydrogenation involves contacting the terpolymer materials either recovered from or still within their polymerization mixtures with hydrogen in the presence of a hydrogenation catalyst to thereby saturate some or all of the residual double bonds within these terpolymers. Functionalization can occur, for example, by epoxidation and/or hydroxylation of some or all of the residual double bonds within the terpolymers.

The foregoing and other features and attributes of the disclosed components, compositions and processes involving the terpolymer materials disclosed herein and their advantageous applications and/or uses will be apparent from the Detailed Description which follows. In this Detailed Description and in the Summary above and in the claims which are provided hereinafter, all numerical values are understood to be modified by the term “about”.

### DETAILED DESCRIPTION

The polymeric materials which are prepared and derivatized as disclosed herein are copolymers comprising at least one α-olefin co-monomer and at two different types of cyclic olefin co-monomers. Accordingly, for purposes herein, a “copolymer” is generically any material which is prepared by co-polymerizing at least two different co-monomer types including the essentially present co-monomers herein derived from α-olefins and cyclic olefins.

Polymeric materials which comprise three different types of co-monomers, as do the polymeric materials of this disclosure, are encompassed by the generic term “copolymer” but are also specifically referred to herein as “terpolymers.” Polymers which are prepared from the three co-monomer types described herein may for purposes of this disclosure still be referred to as “terpolymers” even though such terpolymers may comprise minor amounts of a fourth or even additional co-monomer types. Such materials are also still “terpolymers” for purposes herein even though some co-monomers of the same general type may not all be present in the polymer chain in or with the same chemical structural (e.g., substituted norbornenes), microstructural (e.g., tacticity) or stereochemical configuration.

The term “terpolymer component” is used herein to refer to a mixture of polymeric materials which comprises one or more individual species of terpolymers. The terpolymers within a “terpolymer component” and the terpolymer component itself are considered to be underivatized unless the terpolymer component or the terpolymers therein are specifically referred to as being derivatized (e.g., hydrogenated, epoxidized and/or hydroxylated).

### General Polymer-Forming Reaction Scheme

The basic terpolymers disclosed herein are polyolefins comprising monomeric units derived from ethylene (E), the diene dicyclopentadiene (DCPD) and the cyclic olefin norbornene (NB). In is forming such terpolymers, DCPD and NB are selectively polymerized through enchainment of their norbornene rings in very general terms according to the following reaction Scheme 1 (which implies no specific connectivity between the three monomer components):

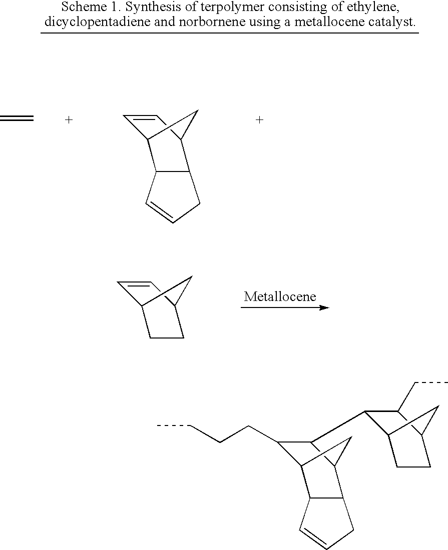

### Terpolymer Components and Characteristics

The three co-monomers—ethylene, dicyclopentadiene and norbornene-based cyclic olefins—are readily available raw materials. Ethylene is produced in the petrochemical industry via steam cracking or catalytic cracking of hydrocarbons. Ethylene can also be produced via catalytic conversion of oxygenate feedstocks using molecular sieve catalysts.

Dicyclopentadiene, C₁₀H₁₂, is a bridged, cyclic unsaturated hydrocarbon found in oil deposits. It is a clear and colorless liquid at room temperature. Dicyclopentadiene is co-produced in large quantities in the steam cracking of naphtha and gas oils to ethylene.

Norbornene, C₇H₁₀, like DCPD, is a bridged cyclic hydrocarbon. Its molecule consists of a cyclohexene ring which is bridged with a methylene group in the para position. Norborne can be made by a Diels-Alder reaction of cyclopentadiene and ethylene.

Norbornene will generally have its olefinic double bond in the cyclohexene ring between two carbon atoms which are not associated with the methylene bridge. Accordingly, this material is generally referred to as 2-norbornene to indicate this double bond positioning.

The 2-norbornene molecule may also be substituted at various positions around the cyclohexene ring. Typical substituted norbornenes include 5-methyl-2-norbornene, 5-ethyl-2-norbornene, 5-propyl-2-norbornene, 7-methyl-2-norbornene, 5-isobutyl-2-norbornene, 5,6-dimethyl-2-norbornene, and 5,5,6-trimethyl-2-norbornene. Substituted norbornenes such as these may also be used to form the norbornene-derived co-monomers used in the terpolymer and derivatized terpolymer components herein. For purposes of this disclosure, the term “norbornene” and the designation “NB” encompass 2-norbornene itself as well as substituted derivatives thereof.

The terpolymer components herein can generally contain from 0.5 mol % to 64.5 mol % of the DCPD-derived monomeric units. Alternatively, this terpolymer component can comprise from 1.0 mol % to 55.0 mol % of the DCPD-derived units. Also, the DCPD content of the terpolymer component herein can range from 1.5 mol % to 50.0 mol %.

The terpolymer components herein can also generally contain from 0.5 mol % to 64.5 mol % of the NB-derived monomeric units. Alternatively, this terpolymer component can comprise from 5.0 mol % to 60.0 mol % of the NB-derived units. Also, the NB content of the terpolymer components herein can range from 10.0 mol % to 55.0 mol %.

In addition to having DCPD-derived and NB-derived monomeric unit contents within the hereinbefore specified ranges, the terpolymer components herein will generally also comprise a certain specified total amount of monomeric units derived from cyclic olefins, e.g., those derived from either DCPD or NB. The total cyclic olefin co-monomer content (e.g., the dicyclopentadiene- and norbornene-derived co-monomer units) in the terpolymer components herein can generally range from 25 mol % to 65 mol %. Alternatively, the terpolymer components herein can comprise from 30.0 mol % to 62.5 mol % of total cyclic olefin-based co-monomer units. Or, the terpolymer components herein can comprise from 35.0 mol % to 60.0 mol % of total cyclic olefin-based co-monomer units.

The terpolymer components herein can generally have a Weight Average Molecular Weight, M_{w}, of greater than 100,000 g/mol as measured versus polyethylene or polystyrene standards by Gel Permeation Chromatography analysis. Alternatively, the terpolymer components herein can have an M_{w} of greater than 140,000, or greater than 160,000, or even greater than 175,000 g/mol. There is no theoretical upper limit to terpolymer molecular weight but as a practical matter such materials can have an M_{w} no greater than 1,000,000 or even 900,000 g/mol.

Alternatively to, or in addition to, having the Weight Average Molecular Weight characteristics hereinbefore described, the terpolymer components of the present invention can also generally have a Number Average Molecular Weight, Mₙ, of greater than 30,000 g/mol also as measured versus polyethylene or polystyrene standards by Gel Permeation Chromatography analysis. Alternatively, the terpolymer components herein can have an Mₙ, of greater than 50,000, or even greater than 65,000, or greater than 75,000 g/mol. There is no theoretical upper limit to terpolymer molecular weight but as a practical matter such materials can have an Mₙ no greater than 800,000 or even 700,000 g/mol.

As noted, Weight and Number Average Molecular weights for these terpolymer materials can be determined in standard fashion using Gel Permeation Chromatography techniques. Specifics of such techniques used for purposes of this disclosure to determine molecular weight values are set forth hereinafter in the Test Methods section.

The E-DCPD-NB terpolymer components herein generally comprise substantially amorphous materials. As used herein, a substantially amorphous polymer is defined to be a polymeric material having a no crystalline component, as evidenced by no discernible melting temperature (Tₘ) in its second heat Differential Scanning Calorimetry (DSC) spectrum, or a polymeric material having a crystalline component that exhibits a second heat DSC Tₘ with a heat of fusion (ΔH_{f}) of less than 0.50 J/g.

The amorphous terpolymer components herein are materials which will generally have glass transition temperature (T_{g}) characteristics as hereinbefore set forth. A simplistic view of the glass transition temperature of a polymeric material is the temperature below which molecules therein have very little mobility. On a larger scale, polymers are rigid and brittle below their glass transition temperature and can undergo plastic deformation above it. T_{g} is usually applicable to amorphous phases such as the terpolymer components of the present disclosure.

The introduction of cyclic olefins, and in particular, fused ring cyclic olefins, into polymers with a saturated polyolefin backbone tends to increase the glass transition temperature, T_{g}, of the polymer. These changes arise from the introduction of catenated chains of the carbon atoms pendant on the saturated polyolefin backbone. In general, for the effect on the T_{g}, the introduction of equal mole fractions of α-olefins and cyclic olefins of approximately equal number of carbon atoms increases with the degree of cyclic structures introduced into the polymer. The T_{g} of the E-DCPD-NB terpolymer components herein is dependent upon the amount of DCPD-derived and NB-derived units in the terpolymers, with higher DCPD and NB contents generally resulting in higher T_{g} values for the terpolymers.

As noted, the glass transition temperature of the copolymers herein is related to the softening point of the material and can be measured via a variety of techniques as discussed in Introduction to Polymer Science and Technology: An SPE Textbook, by H. S. Kaufman and J. Falcetta, John Wiley & Sons, 1977, and Polymer Handbook, 3^{rd} ed., J. Brandup and E. H. Immergut, Eds., John Wiley & Sons, 1989. The DSC techniques utilized in connection with the present disclosure are well known in the art and are described hereinafter in the Test Methods section.

The E-DCPD-NB terpolymer components herein can generally exhibit a glass transition temperature, T_{g}, of from 120° C. to 180° C. At such T_{g} values, these materials can suitably be used as or in engineering thermoplastic compositions. Alternatively, the T_{g} of the terpolymer components herein can range from 125° C. to 170° C., or even from 130° C. to 160° C.

Another feature of preferred E-DCPD-NB terpolymer components herein relates to the desirability of eliminating from such components any significant amount of E-DCPD-NB terpolymer material which has long, crystallizable polyethylene segments in the polymer chain. Likewise, it is also advantageous that the terpolymer components herein contain no significant amount of polyethylene homopolymers.

The presence or absence of both types of materials can be determined by using standard Differential Scanning Calorimetry (DSC) techniques (as described hereinafter in the Test Methods section) in testing the components herein for their thermal transition temperatures. For purposes herein, the absence of long, crystallizable polyethylene polymer segments and polyethylene homopolymers can be confirmed if, during the second heat of DSC analysis, no detectable melting temperature, Tₘ, can be identified. The presence or absence of these undesirable, and hence generally excluded, polyethylene-based moieties can also be determined by standard Crystallization Analysis Fractionation (CRYSTAF) testing. Generally, CRYSTAF testing can demonstrate solubility readings of at least 90%, or at least 92%, or even at least 94%, after completion of CRYSTAF measurements made on the terpolymer materials herein.

### Process for Producing the E-DCPD-NB Terpolymer Components

The E-DCPD-NB terpolymer components herein can be produced via a polymerization reaction which takes place by contacting ethylene with a polymerization mixture containing both the DCPD and NB co-monomers. The polymerization reaction is generally promoted by a selected catalyst or catalyst system and can take place under a selected set of polymerization reaction conditions.

The polymerization mixture can generally comprise from 0.25 molar to 7.4 molar initial concentration of the DCPD co-monomer. Alternatively, the polymerization mixture can contain the DCPD co-monomer at an initial concentration of from 0.40 molar to 7.25 molar. The polymerization mixture can also generally comprise from 0.25 molar to 9.5 molar initial concentration of the NB co-monomer. Alternatively, the polymerization mixture can contain the NB co-monomer at an initial concentration of from 0.40 molar to 8.90 molar. Within the polymerization mixture, the molar ratio of DCPD to NB co-monomers can generally range from 0.026:1 to 29.6:1, or from 0.44:1 to 18.2:1.

Frequently, a diluent or solvent can make up the balance of the polymerization mixture after the co-monomers and the catalyst or catalyst systems hereinafter described have been added. Aliphatic and aromatic hydrocarbons such as hexane, pentane, isopentane, cyclohexane, octane, toluene, xylene, and the like may be suitably used as a diluent or solvent for the polymerization mixture. The polymerization mixture can generally be in liquid or mixed liquid/solid form during the polymerization reaction carried out therein.

Any conventional type of polymerization process may be used to produce the E-DCPD-NB terpolymer components herein. Polymerization methods include high pressure, slurry, bulk, suspension, supercritical, or solution phase, or a combination thereof. Desirably, solution phase or bulk phase polymerization processes can be used.

Polymerization can generally be carried out using a selected single-site metallocene catalyst or catalyst system, advantageously of the type hereinafter described. The catalysts can be in the form of a homogeneous solution, supported, or a combination thereof. Polymerization may be carried out by a continuous, a semi-continuous or batch process and may include use of chain transfer agents, scavengers, or other such additives as deemed applicable. By continuous is meant a system that operates (or is intended to operate) without interruption or cessation. For example a continuous process to produce a polymer would be one where the reactants are continually introduced into one or more reactors and polymer product is continually withdrawn.

A wide variety of transition metal compounds, e.g., metallocenes, are known which, when activated with a suitable activator, will polymerize olefinic monomers selectively to produce either crystalline polymers or amorphous polymers or copolymers. A full discussion of such compounds can be found in PCT Patent Application No. WO 2004/046214, Published Jun. 3, 2004, the entire contents of which are incorporated herein by reference.

The catalysts advantageously used in the production of the E-DCPD-NB terpolymer components of this disclosure include bridged metallocene materials which, upon activation, can selectively polymerize the specified types of comonomers herein to produce generally amorphous terpolymers having the desired DCPD and NB contents, T_{g} values, and molecular weights. Such selected metallocene catalysts are of the general type represented by the bridged, substituted cyclopentadienyl-fluorenyl (Cp-fluorenyl) transition metal compounds conforming to the following Formula (I):

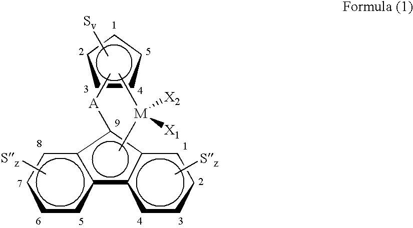

wherein
M is a Group 3, 4, 5 or 6 transition metal atom, lanthanide metal atom, or actinide metal atom, advantageously a Group 4 transition metal atom, or zirconium or hafnium, and desirably zirconium;
each substituent group S and S″ is, independently, a hydrocarbyl, substituted-hydrocarbyl, halocarbyl, substituted-halocarbyl, hydrocarbyl-substituted organometalloid, halocarbyl-substituted organometalloid, disubstituted boron, disubstituted pnictogen, substituted chalcogen or halogen radical, provided that two adjacent S or S″ groups may joined to form a C₄ to C₂₀ ring to give a saturated or unsaturated polycyclic ligand; and
subscript “v” denotes the carbon atom on the cyclopentadienyl ring to which the substituent is bonded and where there can be zero to four of the same or different substituents, S, on the cyclopentadienyl ring; and
subscript “z” denotes the carbon atom on the fluorenyl ring to which the substituent is bonded and where there can be zero to eight of the same or different substituents, S″, on the fluorenyl ring.

Further in Formula (1), A is a bridging group. Such bridging groups can include R′₂C, R′₂Si, R′₂Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′CR′═CR′, R′C═CR′CR′₂CR′₂, R′₂CSiR′₂, R′₂SiSiR′₂, R′₂CSiR′₂CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—R′₂, R′N, R′P, O, S, Se, R′₂C—O—R′₂, R′₂CR′₂C—O—CR′₂CR′₂, R′₂C—O—CR′₂CR′₂, R′₂C—O—CR′═CR′, R′₂C—S—CR′₂, R′₂CR′₂C—S—CR′₂CR′₂, R′₂C—S—CR′₂CR′₂, R′₂C—S—CR′═CR′, R′₂C—Se—CR′₂, R′₂CR′₂C—Se—CR′₂CR′₂, R′₂C—Se—CR′₂CR′₂, R′₂C—Se—CR′═CR′, R′₂C—N═CR′, R′₂C—NR′—CR′₂, R′₂C—NR′—CR′₂CR′₂, R′₂C—NR′—CR′═CR′, R′₂CR′₂C—NR′—CR′₂CR′₂, R′₂C—P═CR′, and R′₂C—PR′CR′₂ where R′ is hydrogen or a C₁-to-C₂₀-containing hydrocarbyl, substituted hydrocarbyl, halocarbyl, substituted halocarbyl, silylcarbyl or germylcarbyl substituent and optionally two or more adjacent R′ may join to form a substituted or unsubstituted, saturated, partially unsaturated or aromatic, cyclic or polycyclic substituent. Examples of the bridging group A include CH₂, CH₂CH₂, C(CH₃)₂, O, S, SiMe₂, SiPh₂, SiMePh, Si(para-trimethylsilylphenyl)₂, and Si(para-triethylsilylphenyl)₂.

Still further in Formula (I), X₁ and X₂ are ligands associated with the M metal. Frequently X₁ and X₂ can, independently, be hydride radicals, hydrocarbyl radicals, substituted hydrocarbyl radicals, halocarbyl radicals, substituted halocarbyl radicals, and hydrocarbyl- and halocarbyl-substituted organometalloid radicals, substituted pnictogen radicals, or substituted chalcogen radicals; or X₁ and X₂ can be joined and bound to the metal atom to form a metallacycle ring containing from 3 to 20 carbon atoms; or X₁ and X₂ together can be an olefin, diolefin or aryne ligand; or when Lewis-acid activators, such as methylaluminoxane, which are capable of donating an X₁ ligand as described above to the transition metal component are used, X₁ and X₂ may independently be a halogen, alkoxide, aryloxide, amide, phosphide or other univalent anionic ligand or both X₁ and X₂ can also be joined to form a anionic chelating ligand and with the proviso that X₁ and X₂ are not a substituted or unsubstituted cyclopentadienyl ring.

Selected metallocene catalysts used in one embodiment of the process herein are those wherein neither the cyclopentadienyl ring nor the fluorenyl moiety in the metallocene catalyst are substituted. If substituents are to be used, then it is advantageous that only the cyclopentadienyl ring and not the fluorenyl moiety be substituted. If the Cp ring is to be substituted, useful Sᵥ substituents include C₁ to C₄ alkyls such as methyl, ethyl, propyl, isopropyl, n-butyl, tert-butyl, or phenyl. Frequently, Sᵥ is methyl. Accordingly, illustrative, but not limiting examples of suitable unsymmetrical cyclopentadienyl metallocenes of the type described in Formula (I) above for use in the process herein are:
μ-CH₂(cyclopentadienyl)(9-fluorenyl)M(R)₂
μ-CH₂(3-methylcyclopentadienyl)(9-fluorenyl)M(R)₂
μ-CH₂(3-isopropylcyclopentadienyl)(9-fluorenyl)M(R)₂
μ-CH₂(3-tert-butylcyclopentadienyl)(9-fluorenyl)M(R)₂
μ-CH₂(3-phenylcyclopentadienyl)(9-fluorenyl)M(R)₂
μ-(CH₃)₂C(cyclopentadienyl)(9-fluorenyl)M(R)₂
μ-(CH₃)₂C(3-methylcyclopentadienyl)(9-fluorenyl)M(R)₂
μ-(CH₃)₂C(3-isopropylcyclopentadienyl)(9-fluorenyl)M(R)₂
μ-(CH₃)₂C(3-tert-butylcyclopentadienyl)(9-fluorenyl)M(R)₂
μ-(CH₃)₂C(3-phenylcyclopentadienyl)(9-fluorenyl)M(R)₂
μ-(CH₃)₂Si(cyclopentadienyl)(9-fluorenyl)M(R)₂
μ-(CH₃)₂Si(3-methylcyclopentadienyl)(9-fluorenyl)M(R)₂
μ-(CH₃)₂Si(3-isopropylcyclopentadienyl)(9-fluorenyl)M(R)₂
μ-(CH₃)₂Si(3-tert-butylcyclopentadienyl)(9-fluorenyl)M(R)₂
μ-(CH₃)₂Si(3-phenylcyclopentadienyl)(9-fluorenyl)M(R)₂
μ-(C₆H₅)₂C(cyclopentadienyl)(9-fluorenyl)M(R)₂
μ-(C₆H₅)₂C(3-methylcyclopentadienyl)(9-fluorenyl)M(R)₂
μ-(C₆H₅)₂C(3-isopropylcyclopentadienyl)(9-fluorenyl)M(R)₂
μ-(C₆H₅)₂C(3-tert-butylcyclopentadienyl)(9-fluorenyl)M(R)₂
μ-(C₆H₅)₂C(3-phenylcyclopentadienyl)(9-fluorenyl)M(R)₂
μ-(C₆H₅)₂Si(cyclopentadienyl)(9-fluorenyl)M(R)₂
μ-(C₆H₅)₂Si(3-methylcyclopentadienyl)(9-fluorenyl)M(R)₂
μ-(C₆H₅)₂Si(3-isopropylcyclopentadienyl)(9-fluorenyl)M(R)₂
μ-(C₆H₅)₂Si(3-tert-butylcyclopentadienyl)(9-fluorenyl)M(R)₂;
μ-(C₆H₅)₂Si(3-phenylcyclopentadienyl)(9-fluorenyl)M(R)₂; and

combinations of these catalysts;

wherein M is selected from Zr and Hf, and R is selected from C₁ and CH₃.

The metallocene catalyst materials hereinbefore described are typically activated in various ways to yield compounds having a vacant coordination site that will coordinate, insert, and polymerize olefin(s). For the purposes herein, the terms “cocatalyst” and “activator” are used herein interchangeably and are defined to be any compound which can activate any one of the catalyst compounds described hereinbefore by converting the neutral catalyst compound to a catalytically active catalyst compound cation. Non-limiting activators, for example, include aluminoxanes, aluminum alkyls, ionizing activators, which may be neutral or ionic, and conventional-type cocatalysts. Suitable activators typically include aluminoxane compounds, modified aluminoxane compounds, and ionizing anion precursor compounds that abstract one reactive, σ-bound metal ligand making the metal complex cationic and providing a charge-balancing noncoordinating or weakly coordinating anion.

Aluminoxanes (also referred to as alumoxanes) are generally oligomeric compounds containing —Al(R¹)—O— sub-units, where R¹ is an alkyl group. Examples of aluminoxanes include methylaluminoxane (MAO), modified methylaluminoxane (MMAO), ethylaluminoxane and isobutylaluminoxane. Alkylaluminoxanes and modified alkylaluminoxanes are suitable as catalyst activators, particularly when the abstractable ligand is a halide, alkoxide or amide. Mixtures of different aluminoxanes and modified aluminoxanes may also be used.

Aluminoxanes may be produced by the hydrolysis of the respective trialkylaluminum compound. MMAO may be produced by the hydrolysis of trimethylaluminum and a higher trialkylaluminum such as triisobutylaluminum. MMAOs are generally more soluble in aliphatic solvents and more stable during storage. There are a variety of methods for preparing aluminoxanes and modified aluminoxanes, non-limiting examples of which are described in U.S. Pat. Nos. 4,665,208, 4,952,540, 5,091,352, 5,206,199, 5,204,419, 4,874,734, 4,924,018, 4,908,463, 4,968,827, 5,308,815, 5,329,032, 5,248,801, 5,235,081, 5,157,137, 5,103,031, 5,391,793, 5,391,529, 5,693,838, 5,731,253, 5,731,451, 5,744,656, 5,847,177, 5,854,166, 5,856,256 and 5,939,346 and European Patent Publication Nos. EP-A-0 561 476, EP-B-0 279 586, EP-A-0 594-218 and EP-B1-0 586 665, and PCT Patent Application Nos. WO 94/10180 and WO 99/15534, all of which are herein fully incorporated by reference. It may be advantageous to use a visually clear methylaluminoxane. A cloudy or gelled aluminoxane can be filtered to produce a clear solution, or clear aluminoxane can be decanted from the cloudy solution. Another useful aluminoxane is Modified Methylaluminoxane Type 3A (commercially available from Akzo Chemicals, Inc., and disclosed in U.S. Pat. No. 5,041,584).

In addition or in place of aluminoxanes, the metallocene catalysts compounds described herein can be activated using an ionizing or stoichiometric activator, neutral or ionic, such as tri(n-butyl)ammonium tetrakis(perfluorophenyl)borate, a tris(perfluorophenyl)boron metalloid precursor, a tris(perfluoronaphthyl)boron metalloid precursor, a polyhalogenated heteroborane anion (PCT Patent Application No. WO 98/43983), boric acid (U.S. Pat. No. 5,942,459) or a combination thereof.

Examples of neutral stoichiometric activators include tri-substituted boron, tellurium, aluminum, gallium and indium complexes or mixtures thereof. The three substituent groups of said activators are each independently selected from alkyls, alkenyls, substituted alkyls, aryls, aryl halides, alkoxy groups, and halides. Suitably, the three groups can be independently selected from halides, mono- or multicyclic (including halosubstituted) aryls, alkyls, and alkenyl compounds and mixtures thereof. Useful substituent groups are alkenyl groups having 1 to 20 carbon atoms, alkyl groups having 1 to 20 carbon atoms, alkoxy groups having 1 to 20 carbon atoms and aryl groups having 3 to 20 carbon atoms (including substituted aryls). Also, the three substituent groups may be alkyls having 1 to 4 carbon groups, phenyl, naphthyl or mixtures thereof. Also suitably, the three groups can be halogenated, preferably fluorinated, aryl groups. Ideally, the neutral stoichiometric activator can be tris(perfluorophenyl)boron or tris(perfluoronaphthyl)boron.

Ionic stoichiometric activator compounds may contain an active proton, or some other cation associated with, but not coordinated to, or only loosely coordinated to, the remaining ion of the ionizing compound. Such compounds and the like are described in European Patent Publication Nos. EP-A-0 570 982, EP-A-0 520 732, EP-A-0 495 375, EP-B1-0 500 944, EP-A-0 277 003 and EP-A-0 277 004, and U.S. Pat. Nos. 5,153,157, 5,198,401, 5,066,741, 5,206,197, 5,241,025, 5,384,299 and 5,502,124, all of which are herein fully incorporated by reference. Ionic catalysts can be prepared by reacting a transition metal compound with a neutral Lewis acid, such as B(C₆F₆)₃, which upon reaction with the X₁ and/or X₂ ligand of the transition metal compound forms an anion, such as ([B(C₆F₅)₃(X)]⁻), which stabilizes the cationic transition metal species generated by the reaction.

Compounds useful as an activator component in the preparation of ionic catalyst systems used in the process herein can comprise a cation, which is frequently a Bronsted acid capable of donating a proton, and a compatible non-coordinating anion which is relatively large (bulky) and capable of stabilizing the active catalyst species (the Group 4 cation) formed when the two compounds are combined. Such an anion will be sufficiently labile to be displaced by olefinic, diolefinic, and acetylenically unsaturated substrates or other neutral Lewis bases such as ethers, nitrites and the like. Two classes of compatible non-coordinating anions have been disclosed in European Patent Publication Nos. EP-A-0 277 003 and EP-A-0 277 004 and include 1) anionic coordination complexes comprising a plurality of lipophilic radicals covalently coordinated to and shielding a central charge-bearing metal or metalloid core, and 2) anions comprising a plurality of boron atoms such as carboranes, metallacarboranes and boranes.

In one embodiment, the ionic stoichiometric activators include a cation and an anion component, and may be represented by the following formula:

(L-H)_{d}⁺(A^{d-})

wherein
L is an neutral Lewis base;
H is hydrogen;
(L-H)⁺ is a Bronsted acid;
A^{d-} is a non-coordinating anion having the charge d−; and
d is an integer from 1 to 3.

The cation component, (L-H)_{d}⁺ may include Bronsted acids such as protons or protonated Lewis bases or reducible Lewis acids capable of protonating or abstracting a moiety, such as an alkyl or aryl, from the transition metal catalyst precursor, resulting in a cationic transition metal species.

Illustrative but not limiting examples of the ionic stoichiometric activator (L-H)_{d}⁺(A^{d-}) are N,N-dimethylanilinium tetrakis(perfluorophenyl)borate, N,N-dimethylanilinium tetrakis(perfluoronaphthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, and tri(n-butyl)ammonium tetrakis(perfluorophenyl)borate.

The catalyst systems used to produce the E-DCPD-NB terpolymer components herein may also include a support material or carrier. For example, one or more catalyst components and/or one or more activators may be deposited on, contacted with, vaporized with, bonded to, or incorporated within, adsorbed or absorbed in, or on, one or more supports or carriers. The support material can be any of the conventional support materials. Advantageously the support material is a porous support material, for example, talc, an inorganic oxide, or an inorganic chloride. Other support materials include resinous support materials such as polystyrene, functionalized or crosslinked organic supports, such as polystyrene/divinylbenzene polyolefins or polymeric compounds, zeolites, clays, any other organic or inorganic support material and the like, or mixtures thereof.

Suitable support materials can be inorganic oxides that include Group 2, 3, 4, 5, 13 or 14 metal oxides. Useful supports include silica, which may or may not be dehydrated, fumed silica, alumina (PCT Patent Application No. WO 99/60033), silica-alumina and mixtures thereof. Other useful supports include magnesia, titania, zirconia, magnesium chloride (U.S. Pat. No. 5,965,477), montmorillonite (European Patent No. EP-B1 0 511 665), phyllosilicate, zeolites, talc, clays (U.S. Pat. No. 6,034,187) and the like. Also, combinations of these support materials may be used, for example, silica-chromium, silica-alumina, silica-titania and the like. Additional support materials may include those porous acrylic polymers described in European Patent No. EP-B1-0 767 184, which is incorporated herein by reference. Other support materials include nanocomposites as described in PCT Patent Application No. WO 99/47598, aerogels as described in PCT Patent Application No. WO 99/48605, spherulites as described in U.S. Pat. No. 5,972,510 and polymeric beads as described in PCT Patent Application No. WO 99/50311, which are all herein incorporated by reference.

As is well known in the art, two or more catalysts and/or activators may also be supported together on one inert support, or the catalysts may be independently placed on two inert supports and subsequently mixed. Of the two methods, the former is especially suitable.

Homogeneous solution polymerization generally involves polymerization in a continuous or batch reactor in which the terpolymers are formed and the starting monomers and catalyst materials are supplied, and are agitated to reduce or avoid concentration gradients. The polymerization process herein can be conducted by maintaining the polymerization mixture at temperature ranging from 25° C. to 110° C., or from 30° C. to 100° C., or even from 60° C. to 90° C.

Temperature control in the reactor can be maintained by balancing the heat of polymerization, with reactor heating or cooling carried out by reactor jackets, external heat exchangers, or internal heating or cooling coils to heat or cool the contents of the reactor as needed, or by using pre-heated or pre-chilled feeds, vaporization of a liquid medium (diluent, monomers or solvent), or combinations of all three. Adiabatic reactors with pre-heated or pre-chilled feeds may also be used.

The polymerization reaction can be carried out by maintaining the polymerization mixture in contact with ethylene at suitable reaction pressures. Ethylene pressure, in fact, may play a role in realizing E-DCPD-NB terpolymers herein of especially desirable T_{g} values. Accordingly, in the polymerization process herein, ethylene pressure may vary between 14.7 psig (101.4 kPa) and 700 psig (4826.3 kPa), or even between 50 psig (344.7 kPa) and 600 psig (4136.9 kPa), and especially between 80 psig (551.6 kPa) and 500 psig (3447.4 kPa).

With respect to apparatus employed in conducting the polymerization process herein, the process can be carried out in a continuous stirred tank reactor, batch reactor or a plug flow reactor, or more than one reactor operated in series or parallel. These reactors may have, or may not have, internal cooling or heating, and the monomer feed may or may not be heated or refrigerated.

The E-DCPD-NB terpolymers formed within the polymerization mixture may be recovered therefrom by any suitable conventional separation means to thereby realize the terpolymer components herein. For example, the formed terpolymer materials can be precipitated from the polymerization reaction mixture using a suitable agent such as methanol and thereafter recovered via filtration. The recovered material can then be further washed, re-precipitated, re-filtered and dried to provide the desired terpolymer components in usable form.

The terpolymers formed within the polymerization mixture may also not be recovered therefrom as is, but may instead be further reacted within the polymerization mixture to form other desired materials. For example, the E-DCPD-NB terpolymers formed within the polymerization mixture may be hydrogenated in situ or functionalized in situ by means of epoxidation and/or hydroxylation of the double bond in the DCPD-derived monomer units within the terpolymer in a manner hereinafter described in greater detail. The resulting hydrogenated or functionalized terpolymer components can then be recovered from the polymerization/derivatization reaction mixture in conventional fashion.

### Derivatization of E-DCPD-NB Terpolymer Components

The E-DCPD-NB terpolymers used herein comprise a polymeric backbone which contains pendant polycyclic moieties in the DCPD-derived co-monomer units as shown in the terpolymerization reaction Scheme 1 set forth above. These pendant polycyclic moieties contain one double bond, and that double bond renders the resulting E-DCPD-NB terpolymers relatively unstable. For example, unsaturation renders these materials susceptible to cross-linking, unintended oxidation and other unwanted side reactions during processing and use.

The presence of the double bonds in the pendant polycyclic moieties, however, also provides the E-DCPD-NB terpolymers of the components herein with a reactive “hook” by and through which they can be readily derivatized, i.e., hydrogenated or functionalized. Such derivatization by hydrogenation or functionalization can occur by means of subjecting the E-DCPD-NB terpolymer components herein to a hydrogenation or oxidation reaction. Hydrogenation results in the pendant polycyclic olefin-containing units of the E-DCPD-NB terpolymers within the components being converted into saturated aliphatic polycyclic units. Such hydrogenated terpolymers are relatively more stable than the unsaturated E-DCPD-NB terpolymers and have properties which make components containing them especially suitable as engineering thermoplastics or precursors thereof.

Functionalization by purposeful oxidation results in the addition of epoxide and/or hydroxyl groups to the pendant polycyclic moieties in the terpolymers within the components herein at the site of, and replacing, the double bonds therein. Such epoxidized and/or hydroxylated terpolymer components have enhanced polarity, miscibility, and filler interaction properties which make them especially suitable as structural engineering thermoplastics or precursors thereof, despite the general increase of T_{g} which is observed upon epoxidation and/or hydroxylation due to the increased rigidity of the DCPD-derived co-monomer units. These materials therefore present additional options for achieving optimum price versus performance balance in structural applications.

### Hydrogenation

One suitable procedure for derivatizing the E-DCPD-NB terpolymer components herein comprises the complete or partial hydrogenation of such materials. Hydrogenation can be carried out by contacting the E-DCPD-NB terpolymer components herein, in a suitable reaction mixture, with hydrogen in the presence of a suitable hydrogenation catalyst or stoichiometric hydrogenation reagent under appropriate hydrogenation reaction conditions.

The reaction mixture for terpolymer hydrogenation can be generally formed by dissolving the E-DCPD-NB terpolymer components in an appropriate solvent, such as substituted or unsubstituted aliphatic or aromatic hydrocarbons (e.g., cyclohexane, toluene, xylenes, tetrachloroethane, or dichlorobenzene). As noted, hydrogenation can be carried out using the same polymerization mixture wherein the E-DCPD-NB terpolymer components have been formed.

Any conventional hydrogenation catalyst or stoichiometric reagent may be employed in the hydrogenation procedure. Such catalysts can include, for example, RuClH(CO)(PPh₃)₃, Co(acac)₃/Bu₃Al, nickel silica alumina, nickel/tungsten sulfides, Co-octanoate/Et₃Al, platinum/palladium, Pd/C, Rh(PPh₃)₃Cl, and the like. (In these formulas, Ph is phenyl, acac is acetylacetonate, Bu is butyl and Et is ethyl.) Such hydrogenation catalysts may be homogenous or heterogeneous (e.g., supported on silicates or aluminum oxides) in form. Suitable hydrogenation catalysts, catalyst systems, and catalyst supports are described in greater detail in U.S. Pat. Nos. 6,191,243 and 6,476,153, both of which are incorporated herein by reference. Such stoichiometric hydrogenation reagents can include, for example, para-toluenesulfonyl hydrazide, as described in Naga et al. Polymer 2006, 47, 520-526, herein incorporated by reference.

Hydrogenation conditions also include conventional hydrogenation reaction temperatures and hydrogen pressures. Hydrogenation temperatures can range, for example, from 45° C. to 180° C., or from 80° C. to 140° C. Hydrogen pressures of from 200 psig (1379.0 kPa) to 1600 psig (11,031.6 kPa), or from 600 psig (4136.9 kPa) to 1000 psig (6894.8 kPa), may be employed. Hydrogenation levels can be complete (100%) or partial (e.g., at least 5% or from about 5% to about 99.9%).

The resulting hydrogenated poly(ethylene-co-dicyclopentadiene-co-norbornene) (hereinafter “H-E-DCPD-NB”) terpolymer components can be recovered from the reaction mixture using any conventional recovery or separation techniques (e.g., precipitation/filtration). Such H-E-DCPD-NB terpolymers retain many of the beneficial thermal, Theological and mechanical properties of the precursor E-DCPD-NB terpolymers but are more stable and less susceptible to degradation.

The H-E-DCPD-NB terpolymer components herein can generally have the same DCPD-derived co-monomer unit and NB-derived co-monomer unit contents as do the non-derivatized E-DCPD-NB terpolymer components hereinbefore described. Such H-E-DCPD-NB terpolymer components will also have the same total amount of DCPD- and NB-derived co-monomer units therein as do their underivatized counterpart terpolymer components.

The H-E-DCPD-NB terpolymer components herein can generally have a Weight Average Molecular Weight, M_{w}, of greater than 100,000 g/mol and/or a Number Average Molecular Weight, Mₙ, of greater than 30,000 g/mol, as measured versus polyethylene or polystyrene standards by GPC analysis. Alternatively, the M_{w} of the hydrogenated terpolymer components herein can be greater than 140,000 g/mol, and/or the Mₙ of such materials can be greater than 50,000 g/mol.

Further, the H-E-DCPD-NB terpolymer components herein can generally have a glass transition temperature, T_{g}, of from 120° C. to 165° C., or even from 130° C. to 160° C. These hydrogenated components can also have from 5% to 100% of the double bonds in the E-DCPD-NB terpolymers therein hydrogenated. Advantageously, from 50% to 100% of the double bonds in the terpolymer component can be hydrogenated.

As with the unsaturated E-DCPD-NB terpolymer components from which they can be derived, the H-E-DCPD-NB terpolymer components herein will advantageously contain no significant amount of crystalline polyethylene homopolymer or crystallizable polyethylene segments within the H-E-DCPD-NB terpolymers. Again, this can be confirmed if the hydrogenated terpolymer components exhibit no detectable crystalline melting point (Tₘ) during the second heat of DSC analysis testing, or have a crystalline component that exhibits a second heat DSC Tₘ with a heat of fusion (ΔH_{f}) of less than 0.50 J/g. Generally too, such hydrogenated terpolymer materials can have CRYSTAF solubility readings of 90% or greater, more preferably of 92% or greater, most preferably of 94% or greater.

### Epoxidation/Hydroxylation

Another suitable procedure for derivatizing the E-DCPD-NB terpolymer components herein comprises functionalization by oxidation, e.g., by epoxidation and/or hydroxylation, of such materials. Oxidation can be carried out with very high conversions of the double bonds of the DCPD-derived monomeric units to oxirane groups and/or to dihydroxyl (diol) groups. Epoxidation and/or hydroxylation can be carried out by contacting the E-DCPD-NB terpolymer components herein, in a suitable reaction mixture, with peroxides or peracids, either with or without the use or presence of an oxidation catalyst and under appropriate oxidation reaction conditions for whatever type and extent of oxidation functionalization is desired.

The reaction mixture for terpolymer epoxidation and/or hydroxylation can be generally formed by dissolving the E-DCPD-NB terpolymers in an appropriate solvent such as substituted or unsubstituted aliphatic or aromatic hydrocarbons (e.g., toluene or chloroform) or perfluorinated alcohols. As noted, functionalization such as epoxidation and/or hydroxylation can be carried out using the same polymerization mixture wherein the E-DCPD-NB terpolymer components have been formed.

In one embodiment, epoxidation of the E-DCPD-NB terpolymer components herein can be brought about when an appropriate epoxidizing agent is added to the reaction mixture containing the E-DCPD-NB terpolymers without using an oxidation catalyst. Peracids are one suitable type of epoxidizing agents for use in catalyst-free epoxidation. Peracids such a 3-chloroperbenzoic acid may be added as such or peracids may be formed in situ within the reaction mixture. One method of peracid formation in situ involves the addition to the reaction mixture of a combination of both hydrogen peroxide and formic acid. Formic acid can be added in a molar ratio to the E-DCPD-NB double bonds of from 10:1 to 30:1. Hydrogen peroxide (H₂O₂) can be added to the reaction mixture in a molar ratio to the E-DCPD-NB double bonds of from 1.01:1 to 5:1. Addition of both formic acid and H₂O₂ to the reaction mixture results in the in situ formation of performic acid as an epoxidizing agent.

Non-catalytic epoxidation conditions also include conventional reaction temperatures and reaction times, generally at ambient pressure. Epoxidation temperatures can range, for example, from 0° C. to 75° C., or even from 20° C. to 60° C. Reaction times for the non-catalytic epoxidation reaction can range from 1 hour to 36 hours, or even from 2 hours to 28 hours. Epoxidation levels can generally range from 50% to 100% of the double bonds in the E-DCPD-NB terpolymer. Minor amounts of byproducts such as formate hemiesters or diols (from ring opening) can form during epoxidations of this type. Such materials can be formed at levels of below 5 mol %.

Epoxidation of the E-DCPD-NB terpolymer components herein can also be brought about using only H₂O₂ as an oxidizing agent in the presence of an oxidation catalyst. And under appropriate conditions, the oxirane rings formed on the E-DCPD-NB terpolymers after using H₂O₂ with an oxidation catalyst can also be further converted, e.g., by hydrolysis, either completely or to some lesser extent to dihydroxyl groups. This can result in partial or complete hydroxylation of the terpolymers instead of, or in addition, to epoxidation.

When a catalyst is to be used to epoxidize or hydroxylate the terpolymers herein, one suitable type of oxidation catalyst is an alkyl trioxorhenium-based material. Generally the alkyl group in the rhenium complex of such a catalyst can contain from 1 to 4 carbon atoms. Generally, this alkyl group can be methyl.

Methyltrioxorhenium has the formula CH₃ReO₃ and has the structure depicted by Structure (I) as follows:

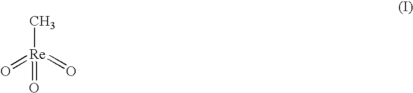

Methyltrioxorhenium is hereinafter designated as “MTO”. MTO is a known material which has been widely studied as an oxygen transfer catalyst in oxidation reactions involving a variety of substrates. The important features of MTO as a catalyst include ease of synthesis, commercial availability and stability to air.

MTO reacts with H₂O₂, an oxidizing agent which can be used in the terpolymer functionalization process herein, in an equilibrium reaction to form monoperoxo- and diperoxo-rhenium (VII) species as shown in the following reaction scheme:

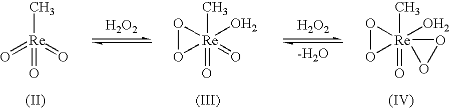

The diperoxo-rhenium (VII) species (Structure IV of the above H₂O₂ activation scheme) is the most reactive towards oxygen-accepting substrates such as the E-DCPD-NB terpolymers, which can be epoxidized and hydroxylated via the process herein.

The MTO/H₂O₂ system involves nontoxic reagents. As noted hereinafter, the oxidation and work-up procedures are relatively simple, and water is the only byproduct. Furthermore, MTO does not decompose H₂O₂ (unlike many transition metal-based catalysts).

The MTO/H₂O₂ system has relatively high acidity, and such high acidity can promote hydrolysis of epoxidized products to hydroxylated, e.g., diol products. Accordingly, when the epoxidized copolymer is the desired primary reaction product, it may be appropriate to add one or more basic ligands to the MTO complex. Such basic ligands can, for example, be nitrogen-containing compounds such as ammonia, or primary, secondary or tertiary amines, including those described in U.S. Pat. No. 5,155,247, incorporated herein by reference. Such ligands can be reacted with the MTO complex prior to the introduction of the MTO-based catalyst into the reaction medium used in the process herein. Alternatively, ligands such as pyridine, bipyridine or other pyridine derivatives can be added to the reaction medium along with the reactants, MTO catalyst and reaction solvents.

The terpolymer epoxidation and/or hydroxylation reactions which use an oxidation catalyst can be carried out in a suitable reaction medium which will generally be a liquid reaction medium. As with the epoxidation reaction hereinbefore described which uses no oxidation catalyst, the liquid reaction medium for catalytic oxidation will generally comprise a suitable reaction solvent in which the reactants and catalyst materials can be dissolved, suspended or dispersed. (For purposes herein, a liquid which does not participate in the reaction and which forms the reaction medium is referred to herein as a “reaction solvent” even though not all of the materials within the reaction medium will necessarily be completely dissolved in or miscible with such a liquid.)

Suitable reaction solvents include organic liquids which are inert in the reaction mixture. By “inert” as used herein in conjunction with reaction solvents is meant that the solvent does not deleteriously affect the epoxidation or hydroxylation reaction relative to its absence and does not increase the formation of non-epoxidized or non-hydroxylated products.

Such suitable inert organic solvents include aromatic hydrocarbons such as benzene, toluene, xylene, benzonitrile, nitrobenzene, adiponitrile, anisole, and phenyl nonane; saturated aliphatic hydrocarbons having from 5 to 20 carbons, such as pentane, hexane, and heptane; halogenated hydrocarbons such as methylene chloride, 1,2-dichloroethane, chloroform, carbon tetrachloride and the like; fluorinated or non-fluorinated substituted saturated aliphatic and/or aromatic hydrocarbons having from 1 to 20 carbons, including alcohols such as methanol, propanol, butanol, isopropanol, 2,4-di-t-butyl phenol, and perfluorinated alcohols; ketones such as acetone; carboxylic acids such as propanoic acid and acetic acid; esters such as ethyl acetate, ethyl benzoate, dimethyl succinate, butyl acetate, tri-n-butyl phosphate and dimethyl phthalate; ethers such as tetraglyme; and mixtures of these solvent types.

Especially suitable organic solvents include toluene, chloroform, and perfluorinated alcohols. The reaction medium may also comprise water. Water, for example, may be introduced as a carrier for the H₂O₂ oxidizing agent.

In one aspect of the disclosure herein, the terpolymer components prepared as hereinbefore described can be converted using the oxidizing agents and catalyst materials also hereinbefore described to primarily epoxidized terpolymer components by subjecting the reaction medium containing these reactants and catalysts to reaction conditions which convert from 50% to 100% of the double bonds in the diene-derived co-monomers to oxirane groups. Certain types and concentrations of reactants and catalysts, as well as relatively lower reaction temperatures and relatively shorter reaction times, tend to favor conversion of the underivatized terpolymer components to primarily epoxidized copolymers.

In another aspect of the disclosure herein, the terpolymer components prepared as hereinbefore described can be converted using the oxidizing agents and catalyst materials also hereinbefore described to primarily dihydroxylated copolymers by subjecting the reaction medium containing these reactants and catalysts to reaction conditions which convert from 50% to 100% of the double bonds in the diene-derived co-monomers to diol moieties. Certain types and concentrations of reactants and catalysts, as well as relatively higher reaction temperatures and relatively longer reaction times, tend to favor conversion of the underivatized terpolymer components to primarily hydroxylated, e.g., diol-containing, functionalized copolymers.

In yet a third aspect of the disclosure herein, there are also some selected reaction conditions which can convert from 50% to 100% of the double bonds in the diene-derived co-monomers in the underivatized terpolymer components being functionalized to both oxirane groups and hydroxyl, e.g., diol, moieties. Such reaction conditions are those which are intermediate to the conditions which promote formation of either all oxirane groups or all hydroxyl (diol) groups within such functionalized terpolymers.

For all types of catalytic oxidation hereinbefore described, the initial concentration of the unsaturated terpolymers to be functionalized can generally range from 0.5 wt % to 40 wt % within the reaction medium. Alternatively, the initial concentration of unsaturated terpolymers to be functionalized can range from 1 wt % to 20 wt %, or even from 2 wt % to 10 wt %.

For all types of catalytic oxidation hereinbefore described, the initial concentration of the H₂O₂ oxidizing agent can generally range from 1 to 100 moles of hydrogen peroxide oxidizing agent for every mole of olefinic carbon-carbon double bonds within the terpolymer components to be subjected to oxidation. More preferably, from 1.05 to 10 moles of H₂O₂ can be added to the reaction medium per mole of unsaturated terpolymer double bonds in the underivatized terpolymer component.

Whether the process involves epoxidation or hydroxylation, the alkyl trioxorhenium-based catalyst, if used, can generally be added to the reaction medium in a concentration of from 0.0001 to 1 mole of alkyl-trioxorhenium-based catalyst for every mole of olefinic carbon-carbon double bonds within the terpolymer component to be subjected to oxidation. Alternately, from 0.001 to 0.1 mole of a methyl-trioxorhenium-based is catalyst can be added per mole of unsaturated terpolymer component double bonds.

Use of ligated alkyl trioxorhenium catalysts, which are less acidic than free alkyl trioxorhenium catalysts, tends to primarily promote formation of epoxidized terpolymers. In contrast, use of more highly acidic, non-ligated alkyl trioxorhenium catalysts tends to promote hydrolysis of any oxirane moieties within the functionalized terpolymer component, thereby tending to primarily form hydroxylated, i.e., diol-containing, terpolymers.

The underivatized terpolymer components herein can be catalytically oxidized to epoxidized copolymers by using relatively mild reaction temperatures and relatively short reaction times. For the catalytic epoxidation embodiments of the present process, the temperature of the reaction medium can generally range from 20° C. to 70° C., or even from 25° C. to 50° C. For production of catalytically epoxidized terpolymeric materials, reaction times can generally range from 0.1 to 24 hours, or even from 0.5 to 18 hours.

The underivatized terpolymer components herein can be catalytically oxidized to hydroxylated, i.e., diol-containing, functionalized terpolymer components by using relatively higher reaction temperatures and relatively longer reaction times. For the catalytic hydroxylation embodiments of the present process, the temperature of the reaction medium can generally range from 50° C. to 100° C., or even from 60° C. to 80° C. For production of hydroxylated terpolymeric materials, reaction times can generally range from 1 to 48 hours, or even from 2 to 36 hours.

Catalytic oxidation process embodiments herein can be carried out using one or more of the foregoing reaction condition parameters in areas where ranges for these parameters overlap for catalytic epoxidation and hydroxylation. Conducting the catalytic oxidation process in this manner can produce functionalized terpolymer components containing both oxirane and diol functionalities.

The resulting epoxidized and/or hydroxylated E-DCPD-NB terpolymers can be recovered from the reaction mixture using any conventional recovery or separation techniques (e.g., precipitation/filtration). Such epoxidized and/or hydroxylated E-DCPD-NB terpolymers retain many of the beneficial thermal, rheological and mechanical properties of the underivatized E-DCPD-NB terpolymers. Epoxidation and/or hydroxylation generally increases the glass transition temperature, T_{g}, of the terpolymer component and imbues polarity, which provides a different balance between properties, cost, and processing range, makes the resulting materials especially useful as or in structural engineering thermoplastics or precursors thereof.

The epoxidized and/or hydroxylated E-DCPD-NB terpolymer components herein can generally have the same DCPD-derived co-monomer unit and NB-derived co-monomer unit contents as do the non-derivatized terpolymer components hereinbefore described. Such epoxidized and/or hydroxylated E-DCPD-NB components can also have the same total amount of DCPD- and NB-derived co-monomer units therein as do their underivatized counterpart terpolymer components.

The epoxidized and/or hydroxylated E-DCPD-NB terpolymer components herein can generally have a Weight Average Molecular Weight, M_{w}, of greater than 100,000 g/mol and/or a Number Average Molecular Weight, Mₙ, of greater than 30,000 g/mol, as measured versus polyethylene or polystyrene standards by GPC analysis. Alternatively, the M_{w} of the epoxidized and/or hydroxylated terpolymer components herein can be greater than 140,000 g/mol, and/or the Mₙ of such materials can be greater than 50,000 g/mol.

Further, the epoxidized and/or hydroxylated E-DCPD-NB terpolymer components herein can also generally have somewhat higher T_{g} characteristics than their unsaturated terpolymer counterparts. The epoxidized and/or hydroxylated E-DCPD-NB terpolymer components herein can generally have a glass transition temperature, T_{g}, of from 130° C. to 185° C., or even from 135° C. to 180° C. These epoxidized and/or hydroxylated terpolymer components can also have from 50% to 100% of the double bonds in the E-DCPD-NB terpolymers epoxidized and/or hydroxylated. Alternatively, from 80% to 100% of the double bonds in the terpolymer components can have oxirane or dihydroxyl groups substituted therefor.

As with the unsaturated E-DCPD-NB terpolymer components from which they can be derived, the epoxidized and/or hydroxylated E-DCPD-NB terpolymer components herein will generally contain no significant amount of crystalline polyethylene homopolymer or crystallizable polyethylene segments within the epoxidized and/or hydroxylated E-DCPD-NB terpolymers. Again, this can be confirmed if the epoxidized and/or hydroxylated terpolymer components exhibit no detectable crystalline melting point (Tₘ) during the second heat of DSC analysis testing, or have a crystalline component that exhibits a second heat DSC Tₘ with a heat of fusion (ΔH_{f}) of less than 0.50 J/g. Generally too, such epoxidized and/or hydroxylated terpolymer materials can have CRYSTAF solubility readings of 90% or greater, or even of 92% or greater, or even of 94% or greater.

### Thermoplastic Polyolefin Compositions

The derivatized terpolymer components herein can be used as, or in, thermoplastic polyolefin compositions which are suitable for use in structural applications. Such derivatized terpolymer components can be the sole component in such thermoplastic polyolefin compositions.

Alternatively, the derivatized terpolymer components herein can be combined with other components within such polyolefin compositions. Other such composition components can include, for example, other types of polyolefins such as α-olefin homopolymers, α-olefin copolymers, and other copolymers of α-olefins and cyclic olefins. Such other polyolefin composition components can also include a wide variety of polymeric materials which can serve as impact modifiers or which can serve to alter and improve other properties of the thermoplastic polyolefin compositions in order to enhance their suitability for structural or other applications. These polyolefin compositions can also optionally comprise a wide variety of fillers, such as talcs, glass fibers, or other inorganic materials; compatibilizing polymers; oligomers or small-molecule compounds; and other additional components used to formulate blends and filled blends.

Generally, the derivatized terpolymer components herein can comprise at least 40 wt % of the thermoplastic polyolefin compositions herein. Alternatively, these derivatized terpolymer components can comprise at least 50 wt %, and even more preferably at least 60 wt %, of the thermoplastic polyolefin compositions herein.

### Test Methods and Analytical Procedures

The various parameters and properties used to characterize the polymeric materials described herein can be determined using conventional or well known analytical or testing methodology, procedures and apparatus. For purposes of determining values for the parameters and characteristics provided for the terpolymer materials of this disclosure, the following methods and procedures are employed.

Solution ¹H nuclear magnetic resonance spectra are collected in d₄-o-dichlorobenzene (ODCB-d₄) at 120° C. on a JEOL Delta 400 MHz instrument with a 5 mm broadband probe. The DCPD content of E-DCPD-NB copolymers is determined using the DCPD resonances at 5.6-5.5 ppm (olefin, 2H), 3.1 ppm (allylic bridgehead, 1H), and 2.5 ppm (non-allylic bridgehead, 1H); NB content is determined by correcting the 2.35-1.8 ppm peak cluster for 4 DCPD protons (cyclopentenyl CH₂ and chain CH's) and assigning the remainder to NB (2 H); and ethylene content is then determined by assigning the remainder of the aliphatic integral (1.8-0.5 ppm peak cluster) to ethylene (4 H) after correction for DCPD (4 H), NB (8 H), and cyclohexane (CH) solvent (sharp peak at 1.4 ppm). Compositions for H-E-DCPD-NB copolymers are determined using the following peak integral assignments: 2.4 ppm, 2H of HDCPD (pendant bridgehead CH); 2.3-1.9 ppm, 2H of HDCPD+2H of NB; 1.9-0.5 ppm, 10H of HDCPD+8H of NB+4H of ethylene after subtraction of contribution from cyclohexane solvent (sharp peak at 1.4 ppm). Compositional analyses for epoxidized poly(ethylene-co-dicyclopentadiene-co-norbornene) (epoxy-E-DCPD-NB) copolymers cannot be performed since no independent markers for norbornene can be obtained (insufficient peak resolution).

Solution ¹³C NMR spectra are collected in 1,1,2,2-tetrachloroethane-d₂ (TCE-d₂) at 120° C., with 15 mg/mL added Cr(acac)₃ relaxation agent, on Varian UnityPlus 500 MHz or Varian Inova 300 MHz instruments with 10 mm broadband probes. The DCPD content of E-DCPD-NB copolymers is determined using the DCPD resonances at 133 and 131 ppm (olefin, 2 C), 54 ppm (allylic bridgehead, 1 C), and 39.5-34 ppm (one norbornyl CH and norbornyl CH₂). Norbornene content is determined by correcting the 52-39.5 ppm peak cluster for 4 DCPD carbons (2 chain CH, non-allylic bridgehead CH, and one norbornyl CH) and assigning the remainder to NB (4 C). Ethylene content is then determined by assigning the remainder of the aliphatic integral (34-24 ppm) to ethylene (2 C) after correcting for DCPD (1 C) and NB (3 C) (no correction for cyclohexane is made). Composition for H-E-DCPD-NB copolymers is determined using the following peak integral assignments: 52-44 ppm, 4 C from HDCPD (CH)+2 C from NB; 44-36 ppm, 3 C from HDCPD (2 CH and 1 CH₂)+2 C from NB; 35-32 ppm, 1 C from NB (C₇CH₂); 32-28 ppm, 1 C from HDCPD (CH₂)+2 C from ethylene+2 C from NB; 28-24 ppm, 2 C from HDCPD (CH₂) after subtraction of contribution from cyclohexane (peak at 27.0 ppm just upfield of HDCPD peak at 26.8 ppm). Composition for epoxy-E-DCPD-NB copolymers is determined using the epoxy-DCPD CHO resonances at 61.2 and 60.1 ppm (total 2 C). NB is determined by correcting the 52-36 ppm region for 7 epoxy-DCPD carbons (all except one CH₂ resonance) and assigning the remainder to NB (4 C); and then assigning the remainder of the aliphatic integral (34-24 ppm) to ethylene (2 C) after correcting for DCPD (1 C) and NB (3 C).

Fourier-Transform Infrared (FTIR or IR) spectra are recorded using a ThermoNicolet Nexus 470 spectrometer running OMNIC software. Differential Scanning Calorimetry (DSC) data are obtained on a TA Instruments model 2920 calorimeter using a scan rate of 10 degrees C. per minute from room temperature to 250 C on the first heat and to 300° C. on the second heat. Glass transition (T_{g}) values reported are midpoints, taken from the second heat cycle.

Gel Permeation Chromatography (GPC) molecular weights for copolymers reported versus polystyrene (PS) are determined using a Waters Associates 2000 Gel Permeation Chromatograph equipped with three Polymer Laboratories mixed bed high-porosity Type LS B columns (10 mm particle size, 7.8 mm inner diameter, 300 mm length) and an internal Waters differential refractive index (DRI) detector. The mobile phase is 1,2,4-trichlorobenzene (degassed and inhibited with 1.5 g/L of 2,6-di-t-butyl-4-methylphenol) at 135° C. (flow rate 1.0 mL/min; 300 mL injection loop). For E-DCPD-NB and epoxy-E-DCPD-NB terpolymers, the typical sample concentration is 1.0 mg/mL; for H-E-DCPD-NB copolymers, 2.0 mg/mL.

Chemical composition distribution (CCD) analysis is measured using a model 200 PolymerChar S. A. Crystallization Analysis Fractionation (CRYSTAF) instrument. The polymer sample (20-30 mg) is dissolved in 30 mL ODCB (stabilized with 0.125 g/L 2,6-di-t-butyl-4-methylphenol) at 160° C. for 60 minutes and equilibrated at 100° C. for 45 minutes, followed by cooling to 30° C. at a rate of 0.2 K/min (analysis time ˜9 hours). A two-wavelength infrared detector is used to measure polymer concentration during crystallization (3.5 μm, 2853 cm⁻¹ sym. stretch) and to compensate for baseline drifts (3.6 μm) during analysis. The solution polymer concentration is monitored at intervals yielding a cumulative concentration curve. The derivative of this curve with respect to temperature represents the weight fraction of crystallized polymer at each temperature (“% soluble by CRYSTAF”).

Powder X-ray diffraction analysis (XRD) is performed using a Bruker Model D-8 Advance diffractometer equipped with a Cu X-ray tube, a monochromator, and a dynamic scintillation detector. A powdered sample of the polymer is evenly distributed onto a low-background holder and given a flat surface for presentation to the X-ray beam. E-DCPD-NB samples are analyzed in comparison to a crystalline homo-polyethylene standard which exhibits strong reflections at 2q=˜22° (d=4.015 Å) and 2q=˜24° (d=3.6510 Å). In contrast, E-DCPD-NB samples exhibit only a broad amorphous enhancement at 2q=˜17°.

Intrinsic viscosity is measured using the ASTM D 1601 procedure (Polyhedron Laboratories, Houston, Tex.). Five-point measurements are made in decalin at 135° C. over the range of 0.12 g/dL to 0.043 g/dL. Inherent viscosities are plotted against concentration, and intrinsic viscosity is calculated by linear extrapolation of the data to 0 g/dL.

In the foregoing detailed description, all patents, test procedures and other documents cited therein, including priority documents, are fully incorporated by reference to the extent such disclosure is not inconsistent with this disclosure and for all jurisdictions in which such incorporation is permitted. When numerical lower limits and numerical upper limits are listed herein, ranges from any lower limit to any upper limit are contemplated.

### EXAMPLES

The following examples illustrate the presently disclosed terpolymer components, compositions and preparation process embodiments and the advantages provided thereby without limiting the scope thereof.

### Example 1

### Synthesis of Poly(Ethylene-co-Dicyclopentadiene-co-Norbornene) (E-DCPD-NB) Copolymer (52.5 mol % Cyclic Co-monomer Content)

In a drybox, two 500 g portions of norbornene were each separately dissolved in 200 mL of anhydrous toluene (dried over 3 Å molecular sieves and sparged with nitrogen) to give two solutions, each 600 mL in volume. The solutions were passed through a column of basic alumina and sparged with nitrogen. A 500 g portion of DCPD was dissolved in 50 mL anhydrous toluene to give a solution of 525 mL total volume, which was treated similarly to the norbornene solution. Subsequently, in the drybox, 1000 mL of the norbornene solution and 100 mL of the DCPD solution were mixed in a round-bottomed flask. A 20 mL portion of a 1 M solution of triisobutylaluminum in toluene was added (Al:Zr ratio 11111:1). The flask was sealed with a septum and removed from the drybox. Its contents were transferred via cannula into a 2 L stainless steel Zipperclave reactor that had been previously sparged with dry nitrogen for two hours. Mechanical stirring was initiated, and the reactor was brought to 75° C. and pressurized with ethylene to 100 psig (689.5 kPa). Polymerization was then initiated by injecting 20 mL of a toluene solution containing 8 mg (0.018 mmol) of p-(CH₃)₂C(cyclopentadienyl)(9-fluorenyl)zirconium dimethyl and 18 mg (0.022 mmol) of N,N-dimethylanilinium tetrakis(pentafluorophenyl)borate. An exotherm to 82° C. was observed. After a reaction time of 30 minutes, the reactor was depressurized and vented. The contents of the reactor were then added to a large beaker containing an excess of stirred methanol. The precipitated polymer was collected by filtration, washed several times with clean methanol, and dried under 30 psig (1.44 kPa) of vacuum overnight to give 115 g of a white material (catalyst activity 12.8 kg polymer/mmol catalyst·h and 14.4 kg polymer/g catalyst; catalyst productivity 68.1 kg polymer/g Zr). A 14 g portion of this material was further purified by dissolution in 622 mL cyclohexane at room temperature (stirring for 3 days to effect complete dissolution) and addition of the polymer solution to 2.24 L acetone. The resultant fine white powder (13.87 g) was collected by vacuum filtration and dried overnight at 50° C. in a vacuum oven followed by further drying at 60° C. for 4 days. Characterization data are given in Table 1 hereinafter.

### Example 2

### Synthesis of E-DCPD-NB Copolymer (47.3 mol % Cyclic Co-monomer Content)

A procedure similar to Example 1 was carried out at a 200 psig (1379.0 kPa) ethylene pressure using 200 mL rather than 100 mL of DCPD solution. A 202 g portion of a white polymer was obtained (catalyst activity 22.4 kg polymer/mmol catalyst·h and 25.3 kg polymer/g catalyst; catalyst productivity 119.7 kg polymer/g Zr). An exotherm to 89° C. was observed upon initiation of polymerization. A 27.2 g portion of this material was further purified by dissolution in 1.21 L cyclohexane at room temperature (stirring for ˜3 days to effect complete dissolution) and addition of the polymer solution to 4.35 L acetone. The resultant fine white powder (28.53 g) was collected by vacuum filtration and dried overnight at 50° C. in a vacuum oven followed by further drying at 60° C. for 4 days. Characterization data are given in Table 1 hereinafter.

### Example 3

### Synthesis of E-DCPD-NB Copolymer (55.6 mol % Cyclic Co-monomer Content)

A procedure similar to Example 1 was carried out using a 20 mL toluene solution containing 16 mg (0.036 mmol) rather than 8 mg of β-(CH₃)₂C(cyclopentadienyl)(9-fluorenyl)zirconium dimethyl and 36 mg (0.044 mmol) rather than 18 mg of N,N-dimethylanilinium tetrakis(pentafluorophenyl)borate to initiate polymerization. A 198 g portion of a white polymer was obtained (catalyst activity 5.5 kg polymer/mmol catalyst-h and 12.4 kg polymer/g catalyst; catalyst productivity 58.6 kg polymer/g Zr). An exotherm to 110° C. was observed upon initiation of polymerization. A 26.9 g portion of this material was further purified by dissolution in 1.20 L cyclohexane at room temperature (stirring for ˜3 days to effect complete dissolution) and addition of the polymer solution to 4.31 L acetone. The resultant fine white powder (25.4 g) was collected by vacuum filtration and dried overnight at 50° C. in a vacuum oven followed by further drying at 60° C. for 4 days. Characterization data are given in Table 1 hereinafter.

### Example 4

### Synthesis of E-DCPD-NB Copolymer (53.3 mol % Cyclic Co-monomer Content and High DCPD Content)

A procedure similar to Example 1 was carried out using 500 mL rather than 1000 mL of norbornene solution and 500 mL rather than 100 mL of DCPD solution. A 117 g portion of a white polymer was obtained (catalyst activity 13.0 kg polymer/mmol catalyst·h and 14.6 kg polymer/g catalyst; catalyst productivity 69.3 kg polymer/g Zr). No exotherm was observed during polymerization; the reactor temperature dropped to below 75° C. A 25.1 g portion of this material was further purified by dissolution in 1.12 L cyclohexane at room temperature (stirring for ˜3 days to effect complete dissolution) and addition of the polymer solution to 4.01 L acetone. The resultant fine white powder (23.7 g) was collected by vacuum filtration and dried overnight at 50° C. in a vacuum oven followed by further drying at 60° C. for 4 days. Characterization data are given in Table 1 hereinafter.

Spectral data for the Example 4 material are given as follows: ¹H NMR (ODCB-d₄, 120° C.): δ 5.6 and 5.5 ppm (each br s, total 2H, DCPD olefin), 3.1 ppm (br s, 1H, DCPD allylic bridgehead), 2.5 ppm (br s, 1H, DCPD non-allylic bridgehead), 2.35-1.8 ppm (br m, major peaks at 2.35, 2.2, 2.1, and 2.0 ppm; 2H from NB+4H from DCPD (cyclopentenyl CH₂ and chain CH resonances)), 1.8-0.5 ppm (br m, major peaks at 1.5, 1.2, and 1.0 ppm; 4H from ethylene+8H from NB+4H from DCPD). ¹³C{¹H} NMR (TCE-d₂, 120° C.): δ 133 and 131 ppm (each s, total 2 C, DCPD olefin), 54 ppm (s with small upfield shoulder at 54.5, 1 C, DCPD allylic bridgehead), 52-39.5 ppm (br m with major peaks at 47.7, 47.0, 42.8, and 41.5 ppm; 4 C from DCPD (2 chain CH+non-allylic bridgehead+norbornyl CH near olefin)+4 C from NB), 39.5-34 ppm (major peaks at 39.0, 38.0, and 36.0 ppm; DCPD norbornyl CH away from olefin+DCPD norbornyl CH₂), 34-24 ppm (major peaks at 32.9, 32.4, and 30.2 ppm; 2 C from ethylene+DCPD cyclopentenyl CH₂+3 C from NB). IR (cast film from CHCl₃ on NaCl): 3038 (m, ν_{olefin C—H}), 2945 (vs), 2868 (s), 1609 (w, ν_{C═C}), 1457 (m), 1446 (m), 1355 (w), 1292 (w), 1269 (w), 1255 (w), 1236 (w), 1215 (m), 1157 (w), 1120 (w), 1103 (w), 1088 (w), 1053 (w), 1036 (w), 968 (w), 944 (w), 925 (w), 884 (w), 869 (w), 793 (sh), 759 (s), 718 (sh), 691 (w), 669 (w) cm⁻¹. Spectral data for the E-DCPD-NB terpolymers prepared as in Examples 1-3 are similar to the above data for Example 4.

A number of characterizing features and parameters for the terpolymers prepared as described in Examples 1-4 are set forth in the following Table 1:

TABLE 1
Characterization of Poly(Ethylene-co-Dicyclopentadiene-co-
Norbornene) Terpolymers.

| | Mol % | | Mol % | | | | | | | |
|---|---|---|---|---|---|---|---|---|---|---|
| | DCPD | | NB | | Total | | | Intr. | CRYS- | |
| Ex. | (NMR) | | (NMR) | | mol % | T_{g} | GPC | visc. | TAF | Wt % |
| No. | ¹H | ¹³C | ¹H | ¹³C | cyclics^{a} | (° C.) | M_{w}; Mₙ | (dL/g) | % sol. | lights^{a} |
| 1 | 4.2 | 4.8 | 48.3 | 48.0 | 52.5 | 155.6 | 625,160; | 1.741 | 96.2 | 0.84 |
| | | | | | | | 312,460 | | | CH |
| 2 | 6.6 | 6.5 | 40.7 | 38.9 | 47.3 | 135.9 | 450,390; | 1.461 | 95.5 | 2.12 |
| | | | | | | | 218,350 | | | CH |
| 3 | 4.7 | 5.0 | 50.9 | 53.9 | 55.6 | —^{b} | 375,830; | 1.113 | 97.4 | 0.25 |
| | | | | | | | 157,680 | | | CH |
| 4 | 23.6 | 23.5 | 29.7 | 30.5 | 53.3 | 158.8 | 224,260; | 1.008 | 98.3 | 1.18 |
| | | | | | | | 106,820 | | | CH |

^{a}By ¹H NMR; CH = residual cyclohexane solvent
^{b}T_{g} not seen; weak T_{g} seen in 1^{st} heat at 146.6° C.

### Example 5

### Synthesis of Hydrogenated Poly(Ethylene-co-Dicyclopentadiene-co-Norbornene) (H-E-DCPD-NB) Copolymer from the Example 1E-DCPD-NB Copolymer

A 5.3 g portion of the E-DCPD-NB copolymer as prepared in Example 1 (3.461 mmol olefin units) was dissolved in 82.5 mL cyclohexane in a glass liner for a 300 mL Hasteloy Parr reactor. A stirbar was added and the polymer was allowed to dissolve in the stirred solvent overnight. Separately, 12 mg (Ph₃P)₃RhCl (0.0126 mmol, 275:1 DCPD:Rh) and 114 mg Ph₃P (0.435 mmol, 34.5:1 P:Rh) were dissolved in 50 mL cyclohexane at 70° C. and stirred for a 30 minute period. The (Ph₃P)₃RhCl/Ph₃P solution was added to the polymer solution (final polymer concentration 4.0 wt/vol %). The stirbar was then removed from the liner and the liner was placed into the Parr reactor, which was assembled and connected to an ethylene manifold. After mechanical stirring was initiated, the reactor was pressurized to 200 psig (1379.0 kPa) H₂ and vented three times, followed by repressurization to 800 psig (5515.8 kPa) H₂ (single charge). The contents of the reactor were stirred at 105° C. overnight (20-22 h); the pressure was raised back to 800 psig (5515.8 kPa) intermittently during the early hours of the hydrogenation. The reactor was cooled and vented and its contents were precipitated into acetone (ca. 300 mL acetone per 100 mL of polymer solution) giving a lumpy white solid. After manually cutting large solids into smaller pieces, the entire polymer solution (precipitate+solvents) was agitated in a Waring blender. The shredded polymer was collected by filtration, rinsed with acetone, and then redissolved in cyclohexane (2.25 wt/vol % polymer) at room temperature and reprecipitated into acetone (360 mL acetone per 100 mL polymer solution; no blending necessary) to give a fine white powder. After collection by filtration, the product (5.16 g) was dried at 80° C. overnight in a vacuum oven. Residual unsaturation was seen by ¹H NMR.

A 5.0 g portion of this material (theo. 3.265 mmol olefin units) was then rehydrogenated with an identical procedure in o-dichlorobenzene (ODCB) solvent using a greater catalyst loading and polymer concentration. The amounts of reagents used were: 75 mL ODCB (65 mL to dissolve polymer; 10 mL for catalyst/phosphine; 6.7 wt/vol % final polymer concentration), 123 mg (Ph₃P)₃RhCl (0.133 mmol, theo. 25:1 DCPD:Rh), and 1.21 g Ph₃P (4.6 mmol, 34.6:1 P:Rh). After reprecipitation and drying in a vacuum oven for 3 days at 80° C., a fine white powder was obtained (4.97 g, theo. yield 5.005 g; 99%). Characterization data are given in Table 2 hereinafter.

### Example 6

### Synthesis of H-E-DCPD-NB Copolymer from the Example 2E-DCPD-NB Copolymer

A 15.0 g portion of the E-DCPD-NB copolymer prepared as in Example 2 (16.005 mmol olefin units) was hydrogenated and purified by a procedure identical to that described in Example 5, using a 2 L linerless Parr reactor (polymer dissolution and catalyst addition were carried out using a 500 mL Erlenmeyer flask) for the first hydrogenation, and a 300 mL Hasteloy Parr reactor with a glass liner for the second hydrogenation. The amounts of reagents used were: first hydrogenation: 375 mL cyclohexane (325 mL to dissolve polymer; 50 mL for catalyst/phosphine; 4.0 wt/vol % final polymer concentration), 54 mg (Ph₃P)₃RhCl (0.0584 mmol, 274:1 DCPD:Rh), and 528 mg Ph₃P (2.02 mmol, 34.5:1 P:Rh) (13.2 g yield); second hydrogenation (13.0 g polymer, theo. 13.871 mmol olefin units): 160 mL ODCB (110 mL to dissolve polymer; 50 mL for catalyst/phosphine; 8.1 wt/vol % final polymer concentration), 262 mg (Ph₃P)₃RhCl (0.283 mmol, theo. 49:1 DCPD:Rh), and 2.56 g Ph₃P (9.78 mmol, 34.5:1 P:Rh). After purification and drying, a fine white powder was obtained (13.24 g, theo. yield 13.026 g; quantitative). Characterization data are given in Table 2 hereinafter.

### Example 7

### Synthesis of H-E-DCPD-NB Copolymer from the Example 3E-DCPD-NB Copolymer

A 14.0 g portion of the E-DCPD-NB copolymer prepared as in Example 3 (9.884 mmol olefin units) was hydrogenated and purified by a procedure identical to that described in Example 6. The amounts of reagents used were: first hydrogenation: 350 mL cyclohexane (300 mL to dissolve polymer; 50 mL for catalyst/phosphine; 4.0 wt/vol % final polymer concentration), 32 mg (Ph₃P)₃RhCl (0.0346 mmol, 286:1 DCPD:Rh), and 313 mg Ph₃P (1.192 mmol, 34.5:1 P:Rh) (13.1 g yield); second hydrogenation (13.0 g polymer, theo. 9.178 mmol olefins): 195 mL ODCB (145 mL to dissolve polymer; 50 mL for catalyst/phosphine; 6.7 wt/vol % final polymer concentration), 332 mg (Ph₃P)₃RhCl (0.359 mmol, 25:1 DCPD:Rh), and 3.25 g Ph₃P (12.39 mmol, 34.5:1 P:Rh). After drying, a fine white powder was obtained (12.7 g, theo. yield 13.013 g; 98%). Characterization data are given in Table 2 hereinafter.

### Example 8

### Synthesis of H-E-DCPD-NB Copolymer from the Example 4E-DCPD-NB Copolymer

A 12.0 g portion of the E-DCPD-NB copolymer prepared as in Example 4 (39.192 mmol olefin units) was hydrogenated and purified by a procedure identical to that described in Example 6. The amounts of reagents used were: first hydrogenation: 300 mL cyclohexane (250 mL to dissolve polymer; 50 mL for catalyst/phosphine; 4.0 wt/vol % final polymer concentration), 135 mg (Ph₃P)₃RhCl (0.146 mmol, 268:1 DCPD:Rh), and 1.32 g Ph₃P (5.032 mmol, 34.5:1 P:Rh) (yield 11.25 g); second hydrogenation (11.2 g polymer, theo. 36.579 mmol olefin units): 160 mL ODCB (110 mL to dissolve polymer; 50 mL for catalyst/phosphine; 7.0 wt/vol % final polymer concentration), 352 mg (Ph₃P)₃RhCl (0.381 mmol, theo. 96:1 DCPD:Rh), and 3.44 g Ph₃P (13.13 mmol, 34.5:1 P:Rh). After drying, hydrogenated H-E-DCPD-NB copolymer was obtained as a fine white powder (10.4 g, theo. yield 11.278 g; 92%). Characterization data are given in Table 2 hereinafter.

Spectral data for the Example 8 material are given as follows: ¹H NMR (ODCB-d₄, 120° C.): δ 2.4 ppm (br s, HDCPD pendant bridgehead CH, 2H), 2.3-1.9 ppm (br m, major peaks at 2.3, 2.2, and 2.17 ppm; 2H of HDCPD (2.2 and 2.17 ppm peaks)+2H of NB), 1.9-0.5 ppm (br m, main peaks at 1.8, 1.7, 1.5, 1.3, 1.2, 1.05, and 1.0 ppm; 10 H of HDCPD+8H of NB+4H of ethylene). Olefinic signals at 5.6-5.5 ppm are absent. ¹³C{¹H} NMR (TCE-d₂, 120° C.): δ 52-44 ppm (m, main peaks at 50.0, 49.0, 47.7, 47.0, 46.3, and 46.0 ppm; 4 C from HDCPD (CH)+2 C from NB), 44-36 ppm (m, main peaks at 42.0, 41.5, 41.0, 40.5, 39.4, 38.7, and 38.2 ppm; 3 C from HDCPD (2 CH and 1 CH₂)+2 C from NB), 35-32 ppm (main peaks at 33.5 and 32.8 ppm; NB C₇CH₂), 32-28 ppm (br m, main peaks at 31.0, 30.6, 30.2, and 29.4 ppm; 1 CH₂ from HDCPD+2 C from ethylene+2 C from NB), 28-24 ppm (peak at 26.8 ppm, 2 C from HDCPD CH₂ (a second peak at 27.0 ppm, when appearing, was assigned to residual cyclohexane solvent)). Olefinic signals at 133 and 131 ppm were absent. IR (cast film from cyclohexane on NaCl): 2945 (vs), 2868 (s), 1470 (sh), 1449 (m), 1358 (w), 1326 (w), 1298 (w), 1273 (w), 1254 (w), 1225 (w), 1186 (w), 1170 (w), 1153 (w), 1138 (w), 1118 (w), 1063 (w), 1038 (w), 1019 (w), 969 (w), 945 (w), 926 (w), 903 (w), 890 (w), 860 (w), 832 (w), 783 (w) cm⁻¹. The characteristic bands seen in the precursor E-DCPD-NB material at 3038 (m, ν_{olefin C—H}), 1609 (w, ν_{C═C}), and 759 (s) were absent. Spectral data for the H-E-DCPD-NB copolymers prepared as in Examples 5-7 are similar to the above data for Example 8.

A number of characterizing features and parameters for the hydrogenated terpolymers prepared as described in Examples 5-8 are set forth in the following Table 2:

TABLE 2
Characterization of Hydrogenated Poly(Ethylene-co-
Dicyclopentadiene-co-Norbornene) Terpolymers.

| | Mol % | | Mol % | | | | | | |
|---|---|---|---|---|---|---|---|---|---|
| | DCPD | | NB | | Total | % | | | |
| Ex. | (NMR) | | (NMR) | | mol % | DCPD | T_{g} | GPC | Wt % |
| No. | ¹H | ¹³C | ¹H | ¹³C | cyclics^{a} | saturation^{a} | (° C.) | M_{w}; Mₙ | lights^{a} |
| 5 | 4.9 | 3.5 | 48.0 | 46.5 | 52.9 | 100 | 153.1 | 534,190; | 0.45 |
| | | | | | | | | 266,290 | CH |
| 6 | 6.9 | 6.5 | 40.5 | 42.3 | 47.4 | 100 | 132.3 | 406,730; | 2.45 |
| | | | | | | | | 205,760 | CH |
| 7 | 5.0 | 5.6 | 53.0 | 52.0 | 58.0 | 100 | 142.9^{b} | 327,350; | — |
| | | | | | | | | 148,820 | |
| 8 | 24.4 | 23.7 | 29.8 | 30.2 | 59.2 | 100 | 155.6 | 203,020; | 2.55 |
| | | | | | | | | 108,970 | CH |

^{a}By ¹H NMR; CH = residual cyclohexane solvent.
^{b}Very weak.

### Example 9

### Synthesis of Epoxidized Poly(Ethylene-co-Dicyclopentadiene-co-Norbornene) (Epoxy-E-DCPD-NB) Copolymer from the Example 1 E-DCPD-NB Copolymer

A 4.5 g portion of the E-DCPD-NB copolymer prepared as in Example 1 (2.939 mmol olefin units) was placed in a reaction flask containing a stirbar and dissolved in 225 mL stirred CHCl₃ (polymer concentration 2.0 wt/vol %). To the polymer solution was added 3.07 g (0.067 mol, 23 eq. per olefin) formic acid, followed by 0.756 g 30 wt % aqueous H₂O₂ (6.67 mmol, 2.3 eq. per olefin). The resultant solution was stirred at room temperature for 18 hours. The reaction mixture then was poured into 1 L stirred methanol, and the solid precipitate was filtered, washed with methanol, and dried under vacuum (0.1 Torr) at 60° C. overnight to give a fully epoxidized material (4.39 g, theo. yield 4.545 g; 97%). Characterization data are given in Table 3 hereinafter.

### Example 10

### Synthesis of Epoxy-E-DCPD-NB Copolymer from the Example 2E-DCPD-NB Copolymer

A 5.0 g portion of the E-DCPD-NB copolymer prepared as in Example 2 (5.335 mmol olefin units) was epoxidized in a manner identical to that described in Example 9. The amounts of reagents used were 250 mL CHCl₃ (polymer concentration 2.0 wt/vol %), 4.94 g formic acid (0.107 mol, 20 eq. per olefin), and 1.218 g 30 wt % aqueous H₂O₂ (10.8 mmol, 2.0 eq. per olefin). A 4.72 g yield of white material (theo. yield 5.085 g; 93%) was obtained after isolation and drying. Characterization data are given in Table 3 hereinafter.

### Example 11

### Synthesis of Epoxy-E-DCPD-NB Copolymer from the Example 3E-DCPD-NB Copolymer

An oven-dried, 1 L three-necked round-bottomed flask was fitted with a stirbar, thermometer, gas inlet/outlet, and addition funnel. A 7.5 g portion of the E-DCPD-NB copolymer prepared as in Example 3 (5.295 mmol olefin units) and 375 mL CHCl₃ were added, and the flask was placed under a nitrogen purge. The polymer solution was stirred under nitrogen for 4 hours to effect dissolution (2.0 wt/vol % polymer concentration). The addition funnel was charged with 5.02 g formic acid (0.109 mol, 20 eq. per olefin), which was added to the polymer solution over a 15 minute period, and subsequently with 1.235 g 30 wt % aqueous H₂O₂ (10.89 mmol, 2.1 eq. per olefin), which was added dropwise over a 10 minute period. No exotherm was observed. The polymer solution was stirred overnight at room temperature under nitrogen, after which time the solution was cloudy due to the presence of water in the CHCl₃. The solution was poured into 2 L stirred methanol, and the precipitated polymer was collected by filtration, stirred in fresh methanol (500 mL) for 2 hours, re-collected by filtration, and dried in a vacuum oven at 40° C. for three days to give 7.29 g of a fluffy white material (theo. yield 7.583 g; 97%). Characterization data are given in Table 3 hereinafter.

### Example 12

### Synthesis of Epoxy-E-DCPD-NB Copolymer from the Example 4E-DCPD-NB Copolymer

An 8.0 g portion of the E-DCPD-NB copolymer prepared as in Example 4 (26.128 mmol olefin units) was epoxidized in a manner identical to that described in Example 11. The amounts of reagents used were 400 mL CHCl₃ (polymer concentration 2.0 wt/vol %), 25.0 g formic acid (0.544 mol, 21 eq. per olefin), 6.17 g 30 wt % aqueous H₂O₂ (54.35 mmol, 2.1 eq. per olefin), and 2.26 L methanol. A 7.91 g portion (theo. yield 8.416 g; 94%) of epoxy-E-DCPD-NB copolymer was obtained after drying. Characterization data are given in Table 3 hereinafter.

Spectral data for the Example 12 material are given as follows: ¹H NMR (ODCB-d₄, 120° C.): δ 3.4 and 3.3 ppm (each s, total 2H, epoxy-DCPD CHO), 2.5-0.8 ppm (br m, main peaks at 2.4 and 2.3 ppm (overlapped s, total 2H, epoxy-DCPD bridgehead CH) and 2.2, 2.14, 2.06, 1.95, 1.8, 1.5, 1.2, 1.06, and 1.0 ppm (8 H from epoxy-DCPD+10 H of NB+4H of ethylene)). Olefinic signals at 5.6-5.5 ppm were absent. ¹³C{¹H} NMR (TCE-d₂, 120° C.): δ 61.2 and 60.1 ppm (each s, epoxy-DCPD CHO, total 2 C), 52-36 ppm (m with main peaks at 50.0, 49.2, 48.4, 47.5, 46.9, 45.5, 44.6, 44.0, 43.4, 41.7, 41.2, 40.4, 39.6, 39.0, 38.3, and 37.2 ppm; 7 C from epoxy-DCPD (all except one CH₂ resonance)+4 D from NB), 34-24 ppm (main peaks at 32.8, 31.0, 30.2, 29.4, and 28.1 ppm; 2 C from ethylene+3 C from NB+1 CH₂ from epoxy-DCPD). Olefinic signals at 133 and 131 ppm were absent. IR (cast film from CHCl₃ on NaCl): 2946 (vs), 2866 (s), 1458 (m), 1446 (m), 1386 (w), 1360 (w), 1307 (w), 1287 (w), 1269 (w), 1240 (w), 1215 (w), 1181 (w), 1156 (w), 1122 (w), 1042 (w), 1018 (w), 921 (w), 878 (w), 834 (s, ν_{C—O}), 809 (w), 756 (s), 666 (w) cm⁻¹. The characteristic bands seen in the precursor E-DCPD-NB material at 3038 (m, ν_{olefin C—H}) and 1609 (w, ν_{C═C}) were absent. Spectral data for the epoxy-E-DCPD-NB terpolymers prepared as in Examples 9-11 are similar to the above data for Example 12.

A number of characterizing features and parameters for the epoxidized terpolymers prepared as described in Examples 9-12 are set forth in the following Table 3:

TABLE 3
Characterization of Epoxidized poly(Ethylene-co-
Dicyclopentadiene-co-Norbornene) Terpolymers.

| | Mol % | | | | | | | |
|---|---|---|---|---|---|---|---|---|
| | DCPD | | Mol % NB | | Total | % | | |
| | (NMR) | | (NMR) | | mol % | DCPD | T_{g} | GPC |
| Ex. No. | ¹H^{a} | ¹³C | ¹H^{a} | ¹³C | cyclics^{a} | Epoxidation^{b} | (° C.) | M_{w}; Mₙ |
| 9 | NA | 4.2 | NA | 50.4 | 54.6 | 100 | 157.0 | 506,390; |
| | | | | | | | | 222,140 |
| 10 | NA | 8.1 | NA | 35.0 | 43.1 | 100 | 138.4 | 398,060; |
| | | | | | | | | 129,310 |
| 11 | NA | 4.3 | NA | 54.9 | 59.2 | 100 | 147.4^{c} | 327,870; |
| | | | | | | | | 128,900 |
| 12 | NA | 22.9 | NA | 29.8 | 52.7 | 100 | 176.3 | 176,130; |
| | | | | | | | | 80,320 |

^{a}Insufficient peak resolution in spectrum.
^{b}By ¹³C NMR.
^{c}Very weak.

### Example 13

### Methyltrioxorhenium Based Catalytic Epoxidation of E-DCPD-NB Terpolymer

In this example, an E-DCPD-NB terpolymer was functionalized by MTO-catalyzed epoxidation. The E-DCPD-NB terpolymer contained 2 mol % DCPD, 70 mol % ethylene, and 28 mol % NB; its GPC Mₙ=50,360 and its M_{w}=125,700. Initially, 0.5 g of this E-DCPD-NB terpolymer (0.0002057 mol DCPD units) was charged into a round bottom flask and was dissolved in 25 mL chloroform (2 wt/vol % polymer solution). To this solution was added 0.05 g (0.00041 mol) of 30 wt % H₂O₂ and then 0.001 g of MTO. The solution was stirred at room temperature. After two hours, the product was precipitated by addition of the solution to methanol, filtered, washed with methanol, and dried in vacuum at 60° C. for 24 hours. The yield of the product was 4.5 g. The IR spectrum of the product showed the absorption band at 835 cm⁻¹, characteristic of the epoxy-E-DCPD-NB epoxide group, and absence of double bond bands at 1610, 1103, and 945 cm⁻¹. The ¹³C NMR spectrum of the product suggested that 100% of DCPD double bonds were epoxidized. Thus, the spectroscopic data (NMR and IR) showed that there was a quantitative epoxidation reaction using MTO catalyst. GPC analysis of the product showed a monomodal distribution with Mₙ=55,520 and M_{w}=141,000 versus polyethylene (rather than polystyrene) standards.

### Example 14

### Methyltrioxorhenium Based Catalytic Epoxidation of E-DCPD-NB Terpolymer (Repeat)

The same E-DCPD-NB terpolymer of Example 13 was used in this example. Initially 2.0 g of E-DCPD-NB (0.00083 mol DCPD units) was charged into a round bottom flask and dissolved in 100 mL CHCl₃ (2 wt/vol % polymer solution). To this solution was added 0.40 g (0.0035 mol) 30 wt % H₂O₂ and then 0.08 g (0.00032 mol) MTO. The solution was stirred at 25° C. After 18 hours, the product was precipitated by addition of the solution to methanol, filtered, washed with methanol, and dried in vacuum at 60° C. for 24 hours. The yield of the product was 1.86 g. The IR spectrum of the product showed the absorption band at 835 cm⁻¹ characteristic of the epoxy-E-DCPD-NB epoxide group, and absence of double bond bands at 1610, 1103 and 945 cm⁻¹. The ¹³C NMR spectrum of the product showed that the reaction product was quantitatively epoxidized with no detectable olefin signals. GPC analysis of the product showed a monomodal distribution with Mₙ=57,100 and M_{w}=132,530 versus polyethylene (rather than polystyrene) standards.

### Example 15

### Methyltrioxorhenium Based Catalytic Hydroxylation of E-DCPD-NB Terpolymer

Initially, 0.5 g of the same E-DCPD-NB terpolymer (0.0002057 mol DCPD units) used in Examples 13 and 14 was charged into a round bottom flask and dissolved in 25 mL CHCl₃ (2 wt/vol % polymer solution). To this solution was added 0.05 g (0.00041 mol) of 30 wt % H₂O₂ and then 0.001 g (0.004 mmol) MTO. The solution was heated and stirred at 70° C. After 18 hours, the product was precipitated by addition of the polymer solution to methanol, filtered, washed with methanol, and dried in vacuum at 60° C. for 24 hours. The yield of the product was 4.5 g. The IR spectrum of the product showed an absorption band at 3390 cm⁻¹, characteristic of the E-DCPD-NB dihydroxyl groups, and absence of double bond bands at 1610, 1103 and 945 cm⁻¹. GPC analysis of the product showed a monomodal distribution with Mₙ=45,490 and M_{w}=129,150 versus polyethylene (rather than polystyrene) standards.

### Example 16

### Methyltrioxorhenium Based Catalytic Epoxidation and Hydroxylation of E-DCPD-NB Terpolymer

Initially, 3.0 g of the same E-DCPD-NB terpolymer (0.001234 mol DCPD units) used in Examples 13, 14 and 15 was charged into a round bottom flask and dissolved in 150 mL CHCl₃ (2 wt/vol % polymer solution). To this solution was added 0.60 g (0.00492 mol) of 30 wt % H₂O₂ and then 0.12 g (0.00048 mol) MTO. The solution was heated and stirred at 70° C. After 18 hours, the product was precipitated by addition of the polymer solution to methanol, filtered, washed with methanol, and dried in vacuum at 60° C. for 24 hours. The yield of the product was 2.8 g. The IR spectrum of the product showed the absorption band at 3390 cm⁻¹, characteristic of the E-DCPD-NB dihydroxyl groups and absence of double bond bands at 1610, 1103 and 945 cm⁻¹. The ¹³C NMR spectrum of the product shows that the terpolymer is quantitatively functionalized with no detectable olefin signals.

The product was examined by solid-state ¹³C NMR in order to quantify the conversion of the DCPD unit 1,2-disubstituted olefins to epoxide and/or diol groups. Bloch decay (single-pulse with a 60 s pulse delay) and cross-polarization magic-angle spinning (CPMAS with 1.5 ms contact time and 1 s pulse delay) spectra were acquired at a spinning speed of 8 kHz on a Chemagnetics CMX-200 MHz spectrometer with a 5 mm probe. In both of the experiments, proton decoupling was used during data acquisition. Peaks typically identified in the spectra for functionalized DCPD units are those for formate hemiesters (carbonyl C═O at ˜160 ppm; CHOH and CHOC(═O)H at ˜80 ppm), 1,2-disubstituted olefins (˜130 ppm), diols (CHOH at ˜80 ppm), and epoxides (CHO carbons at ˜60 ppm).

The ¹³C CPMAS NMR spectrum was deconvoluted into peaks comprising diols, epoxides, and the remainder of the aliphatic region. The relative functional group distribution of the DCPD units in the product was: diol groups, 72 mol %, epoxide groups, 28 mol %. There were no 1,2-disubstituted olefin peaks. Thus, the solid-state ¹³C NMR spectrum showed a high level of hydroxylation using the MTO catalyst. GPC analysis of the product showed a monomodal distribution with Mₙ=36,450 and M_{w}=138,400 versus polyethylene (rather than polystyrene) standards.

### Example 17

### Methyltrioxorhenium Based Catalytic Hydroxylation of E-DCPD-NB Terpolymer (Repeat)

Initially, 2.0 g of the same E-DCPD-NB terpolymer (0.00083 mol DCPD units) used in Examples 13, 14, 15 and 16 was charged into a round bottom flask and dissolved in 100 mL CHCl₃ (2 wt/vol % polymer solution). To this solution was added 0.40 g (0.0035 mol) of 30 wt % H₂O₂ and then 0.08 g (0.00032 mol) MTO. The solution was heated and stirred at 70° C. After 18 hours, the product was precipitated by addition of the polymer solution to methanol, filtered, washed with methanol, and dried in vacuum at 60° C. for 24 hours. The yield of the product was 1.91 g. The IR spectrum of the product showed the absorption band at 3390 cm⁻¹, characteristic of the E-DCPD-NB dihydroxyl groups and absence of double bond bands at 1610, 1103 and 945 cm⁻¹. GPC analysis of the product showed a monomodal distribution with Mₙ=32,560 and M_{w}=101,600 versus polyethylene (rather than polystyrene) standards.

An attempt has been made herein to disclose all embodiments and applications of the disclosed subject matter that could be reasonably foreseen. However, there may be unforeseeable, insubstantial modifications which remain as equivalents. While the present disclosure has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description and examples.

What is claimed is:

1. Terpolymer components which comprise terpolymers derived from ethylene, dicyclopentadiene and norbornene-based co-monomers, wherein said terpolymer components:
a) have a dicyclopentadiene-derived co-monomer unit content of from 0.5 mol % to 64.5 mol %;
b) have a norbornene-derived co-monomer unit content of from 0.5 mol % to 64.5 mol %;
c) have a total dicyclopentadiene- and norbornene-derived co-monomer unit content of from 25 mol % to 65 mol %;
d) have a Weight Average Molecular Weight, M_{w}, of greater than 100,000 g/mol; and/or a Number Average Molecular Weight, Mₙ, of greater than 30,000 g/mol; and
e) comprise substantially amorphous material having a glass transition temperature, T_{g}, of from 120° C. to 180° C.

2. Terpolymer components according to claim 1, which terpolymer components have a glass transition temperature, T_{g}, which ranges from 130° C. to 160° C.

3. Terpolymer components according to claim 1, which terpolymer components have a dicyclopentadiene-derived co-monomer unit content of from 1.5 mol % to 50 mol %.

4. Terpolymer components according to claim 1, which terpolymer components have a norbornene-derived co-monomer unit content of from 10 mol % to 55 mol %.

5. Terpolymer components according to claim 1, which terpolymer components have a total dicyclopentadiene- and norbornene-derived co-monomer unit content of from 35 mol % to 60 mol %.

6. Terpolymer components according to claim 1, which terpolymer components have a weight average molecular weight, M_{w}, of greater than 175,000 g/mol and/or a Number Average Molecular Weight, Mₙ, of greater than 75,000 g/mol.

7. Terpolymer components according to claim 1 wherein the norbornene-derived co-monomers within said terpolymer components are based on a material selected from 2-norbornene, 5-methyl-2-norbornene, 5-ethyl-2-norbornene, 5-propyl-2-norbornene, 7-methyl-2-norbornene, 5-isobutyl-2-norbornene, 5,6-dimethyl-2-norbornene, 5,5,6-trimethyl-2-norbornene, and combinations thereof.

8. Terpolymer components according to claim 1, which terpolymer components comprise no significant amount of crystalline polyethylene homopolymer or crystallizable polyethylene segments within said terpolymer components.

9. Derivatized terpolymer components comprising terpolymer components according to claim 1 which have been derivatized by hydrogenation, and/or by epoxidation and/or hydroxylation of some or all of the residual double bonds present prior to said derivatization in the dicyclopentadiene-derived co-monomers within said terpolymer components.

10. Hydrogenated terpolymer components which comprise terpolymers derived from ethylene, dicyclopentadiene and norbornene-based co-monomers, and wherein said hydrogenated terpolymer components:
a) have a dicyclopentadiene-derived co-monomer unit content of from 0.5 mol % to 64.5 mol %;
b) have a norbornene-derived co-monomer unit content of from 0.5 mol % to 64.5 mol %;
c) have a total dicyclopentadiene- and norbornene-derived co-monomer unit content of from 25 mol % to 65 mol %;
d) have a Weight Average Molecular Weight, M_{w}, of greater than 100,000 g/mol; and/or a Number Average Molecular Weight, Mₙ, of greater than 30,000 g/mol;
e) comprise substantially amorphous material having a glass transition temperature, T_{g}, of from 120° C. to 165° C.; and
f) have hydrogenated from 5% to 100% of the residual double bonds which were present prior to hydrogenation in the dicyclopentadiene-derived co-monomers within said terpolymers.

11. Hydrogenated terpolymer components according to claim 10 which comprise no significant amount of crystalline polyethylene homopolymer or crystallizable polyethylene segments within said hydrogenated terpolymer components.

12. Hydrogenated terpolymer components according to claim 10 wherein said hydrogenated terpolymer components have a dicyclopentadiene-derived co-monomer unit content of from 1.5 mol % to 50 mol %.

13. Hydrogenated terpolymer components according to claim 10 wherein said hydrogenated terpolymer components have a norbornene-derived co-monomer unit content of from 10 mol % to 55 mol %.

14. Hydrogenated terpolymer components according to claim 10 wherein said hydrogenated terpolymer components have a total dicyclopentadiene- and norbornene-derived co-monomer unit content of from 35 mol % to 60 mol %.

15. Hydrogenated terpolymer components according to claim 10 which have hydrogenated from 50% to 100% of the residual double bonds present prior to hydrogenation in the dicyclopentadiene-derived co-monomers within said terpolymers.

16. Hydrogenated terpolymer components according to claim 15 wherein the norbornene-derived co-monomers within said terpolymers are based on a material selected from 2-norbornene, 5-methyl-2-norbornene, 5-ethyl-2-norbornene, 5-propyl-2-norbornene, 7-methyl-2-norbornene, 5-isobutyl-2-norbornene, 5,6-dimethyl-2-norbornene, 5,5,6-trimethyl-2-norbornene, and combinations thereof.

17. Epoxidized and/or hydroxylated terpolymer components which comprise terpolymers derived from ethylene, dicyclopentadiene and norbornene-based co-monomers, and wherein said epoxidized and/or hydroxylated terpolymer components:
a) have a dicyclopentadiene-derived co-monomer unit content of from 0.5 mol % to 64.5 mol %;
b) have a norbornene-derived co-monomer unit content of from 0.5 mol % to 64.5 mol %;
c) have a total dicyclopentadiene- and norbornene-derived co-monomer unit content of from 25 mol % to 65 mol %;
d) have a Weight Average Molecular Weight, M_{w}, of greater than 100,000 g/mol; and/or a Number Average Molecular Weight, Mₙ, of greater than 30,000 g/mol;
e) comprise substantially amorphous material having a glass transition temperature, T_{g}, of from 135° C. to 180° C.; and
f) have converted, via oxidation to oxirane rings and/or dihydroxyl groups, from 50% to 100% of the residual double bonds which were present prior to oxidation in the dicyclopentadiene-derived co-monomers within said terpolymers.

18. Epoxidized and/or hydroxylated terpolymer components according to claim 17 which comprise no significant amount of crystalline polyethylene homopolymer or crystallizable polyethylene segments within said epoxidized and/or hydroxylated terpolymer components.

19. Epoxidized and/or hydroxylated terpolymer components according to claim 17 wherein said epoxidized and/or hydroxylated terpolymer components have a dicyclopentadiene-derived co-monomer unit content of from 1.5 mol % to 50 mol %.

20. Epoxidized and/or hydroxylated terpolymer components according to claim 17 wherein said epoxidized and/or hydroxylated terpolymer components have a norbornene-derived co-monomer unit content of from 10 mol % to 55 mol %.

21. Epoxidized and/or hydroxylated terpolymer components according to claim 17 wherein said epoxidized and/or hydroxylated terpolymer components have a total dicyclopentadiene- and norbornene-derived co-monomer unit content of from 35 mol % to 60 mol %.

22. Epoxidized and/or hydroxylated terpolymer components according to claim 17 which have oxirane rings and/or dihydroxyl groups formed at from 80% to 100% of the residual double bonds which were present prior to epoxidation and/or hydroxylation in the dicyclopentadiene-derived co-monomers within said terpolymers.

23. Epoxidized and/or hydroxylated terpolymer components according to claim 22 wherein the norbornene-derived co-monomers within said terpolymers are based on a material selected from 2-norbornene, 5-methyl-2-norbornene, 5-ethyl-2-norbornene, 5-propyl-2-norbornene, 7-methyl-2-norbornene, 5-isobutyl-2-norbornene, 5,6-dimethyl-2-norbornene, 5,5,6-trimethyl-2-norbornene, and combinations thereof.

24. Epoxidized terpolymer components according to claim 23 wherein said terpolymers primarily comprise epoxidized terpolymers and contain less than 5 mol % of DCPD units bearing formate hemiester and/or diol substituents.

25. Thermoplastic polyolefin compositions suitable for use in structural applications, which compositions comprise one or more derivatized terpolymer components according to claim 9.

26. Thermoplastic polyolefin compositions suitable for use in structural applications, which compositions comprise one or more hydrogenated terpolymer components according to claim 10.

27. Thermoplastic polyolefin compositions suitable for use in structural applications, which compositions comprise one or more epoxidized and/or hydroxylated terpolymer components according to claim 17.

28. A process for preparing ethylene/dicyclopentadiene/norbornene terpolymer components according to claim 1, which process comprises:
contacting ethylene with a polymerization mixture comprising from 0.25 to 7.4 molar dicyclopentadiene comonomer and from 0.25 to 9.5 molar norbornene co-monomer, with an activated metallocene catalyst under polymerization conditions including a temperature of from 25° C. to 110° C. and an ethylene pressure of from 101.4 kPa (14.7 psig) to 4826.3 kPa (700 psig) for a period of time sufficient to form ethylene-dicyclopentadiene-norbornene terpolymers within said polymerization mixture; and
recovering or further reacting said ethylene-dicyclopentadiene-norbornene terpolymers from or within said polymerization mixture;
wherein said metallocene catalyst has the formula: 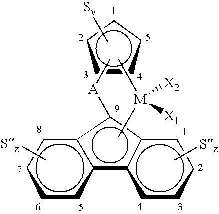
wherein
M is a Group 3, 4, 5 or 6 transition metal atom, lanthanide metal atom, or actinide metal atom;
each substituent group S and S″ is, independently, a hydrocarbyl, substituted-hydrocarbyl, halocarbyl, substituted-halocarbyl, hydrocarbyl-substituted organometalloid, halocarbyl-substituted organometalloid, disubstituted boron, disubstituted pnictogen, substituted chalcogen or halogen radical, provided that two adjacent S or S″ groups may joined to form a C₄ to C₂₀ ring to give a saturated or unsaturated polycyclic ligand; and
subscript “v” denotes the carbon atom on the cyclopentadienyl ring to which the substituent is bonded and where there can be zero to four of the same or different substituents, S, on the cyclopentadienyl ring;
subscript “z” denotes the carbon atom on the fluorenyl ring to which the substituent is bonded and where there can be zero to eight of the same or different substituents, S″, on the fluorenyl ring;
A is a bridging group; and
X₁ and X₂ are ligands associated with the metal M.

29. A process according to claim 28 wherein said polymerization mixture comprises dicyclopentadiene and norbornene in a molar ratio which ranges from 0.026:1 to 20.6:1.

30. A process according to claim 29 wherein M in the structure of the metallocene catalyst is zirconium or hafnium.

31. A process according to claim 30 wherein the bridging group A of the metallocene catalyst is isopropylidene.

32. A process according to claim 31 wherein both the cyclopentadienyl group and the fluorenyl group of the metallocene catalyst are unsubstituted.

33. A process according to claim 30 wherein said metallocene catalyst is selected from:
μ-CH₂(cyclopentadienyl)(9-fluorenyl)M(R)₂
μ-CH₂(3-methylcyclopentadienyl)(9-fluorenyl)M(R)₂
μ-CH₂(3-isopropylcyclopentadienyl)(9-fluorenyl)M(R)₂
μ-CH₂(3-tert-butylcyclopentadienyl)(9-fluorenyl)M(R)₂
μ-CH₂(3-phenylcyclopentadienyl)(9-fluorenyl)M(R)₂
μ-(CH₃)₂C(cyclopentadienyl)(9-fluorenyl)M(R)₂
μ-(CH₃)₂C(3-methylcyclopentadienyl)(9-fluorenyl)M(R)₂
μ-(CH₃)₂C(3-isopropylcyclopentadienyl)(9-fluorenyl)M(R)₂
μ-(CH₃)₂C(3-tert-butylcyclopentadienyl)(9-fluorenyl)M(R)₂
μ-(CH₃)₂C(3-phenylcyclopentadienyl)(9-fluorenyl)M(R)₂
μ-(CH₃)₂Si(cyclopentadienyl)(9-fluorenyl)M(R)₂
μ-(CH₃)₂Si(3-methylcyclopentadienyl)(9-fluorenyl)M(R)₂
μ-(CH₃)₂Si(3-isopropylcyclopentadienyl)(9-fluorenyl)M(R)₂
μ-(CH₃)₂Si(3-tert-butylcyclopentadienyl)(9-fluorenyl)M(R)₂
μ-(CH₃)₂Si(3-phenylcyclopentadienyl)(9-fluorenyl)M(R)₂
μ-(C₆H₅)₂C(cyclopentadienyl)(9-fluorenyl)M(R)₂
μ-(C₆H₅)₂C(3-methylcyclopentadienyl)(9-fluorenyl)M(R)₂
μ-(C₆H₅)₂C(3-isopropylcyclopentadienyl)(9-fluorenyl)M(R)₂
μ-(C₆H₅)₂C(3-tert-butylcyclopentadienyl)(9-fluorenyl)M(R)₂
μ-(C₆H₅)₂C(3-phenylcyclopentadienyl)(9-fluorenyl)M(R)₂
μ-(C₆H₅)₂Si(cyclopentadienyl)(9-fluorenyl)M(R)₂
μ-(C₆H₅)₂Si(3-methylcyclopentadienyl)(9-fluorenyl)M(R)₂
μ-(C₆H₅)₂Si(3-isopropylcyclopentadienyl)(9-fluorenyl)M(R)₂
μ-(C₆H₅)₂Si(3-tert-butylcyclopentadienyl)(9-fluorenyl)M(R)₂;
μ-(C₆H₅)₂Si(3-phenylcyclopentadienyl)(9-fluorenyl)M(R)₂; and
combinations of said catalysts;
wherein M is selected from Zr and Hf, and R is selected from C₁ and CH₃.

34. A process according to claim 28 wherein said metallocene catalyst is activated by the presence of a co-catalyst activator which is selected from aluminoxanes, modified aluminoxanes and ionic stoichiometric activators selected from N,N-dimethylanilinium tetrakis(perfluorophenyl)borate, N,N-dimethylanilinium tetrakis(perfluoronaphthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, and triphenylcarbenium tetrakis(perfluorophenyl)borate.

35. A process according to claim 34 wherein the ethylene pressure ranges from 344.7 kPa (50 psig) to 4136.9 kPa (600 psig) and wherein the polymerization mixture includes a solvent or diluent.

36. A process for preparing derivatized terpolymer components, which process comprises contacting one or more ethylene-dicyclopentadiene-norbornene terpolymer components prepared according to claim 28, either after recovery from or in situ within said polymerization mixture, with a derivatizing agent to bring about hydrogenation and/or epoxidation and/or dihydroxylation of the double bonds in some or all of the dicyclopentadiene-derived co-monomers in said terpolymer components.

37. A process for preparing hydrogenated terpolymer components, which process comprises contacting one or more ethylene-dicyclopentadiene-norbornene terpolymer components prepared according to claim 28 with hydrogen in the presence of a hydrogenation catalyst under hydrogenation reaction conditions of temperature and pressure suitable to effect hydrogenation of from 50% to 100% of the double bonds within said ethylene-dicyclopentadiene-norbornene terpolymer components.

38. A process according to claim 37 wherein said hydrogenation catalyst is selected from RuClH(CO)(PPh₃)₃, Co(acac)₃/Bu₃Al, nickel silica alumina, nickel/tungsten sulfides, Co-octanoate/Et₃Al, platinum/palladium, Pd/C, Rh(PPh₃)₃Cl and combinations thereof, and wherein said hydrogenation reaction conditions include hydrogenation temperatures ranging from 45° C. to 180° C., and hydrogen pressures ranging from 1379.0 kPa (200 psig) to 11031.6 kPa (1600 psig).

39. A process for preparing epoxidized and/or hydroxylated terpolymer components, which process comprises contacting one or more ethylene-dicyclopentadiene-norbornene terpolymer components prepared according to claim 28 with a peroxide or peracid oxidizing agent in a solvent under oxidation reaction conditions suitable to effect oxirane ring and/or dihydroxyl group formation at from 50% to 100% of the double bonds within said ethylene-dicyclopentadiene-norbornene terpolymer components, to thereby form epoxidized and/or hydroxylated terpolymer components.

40. A process according to claim 39 wherein said solvent is selected from toluene and chloroform, said oxidizing agent is selected from 3-chloroperbenzoic acid and combinations of hydrogen peroxide and formic acid, and said oxidation reaction conditions include oxidation temperatures ranging from 0° C. to 75° C. and wherein said oxidized terpolymer components are primarily epoxidized.

41. A process according to claim 39 wherein said oxidizing agent is selected from hydrogen peroxide or derivatives thereof, and said oxidation reaction conditions include the presence of an oxidation catalyst.

42. A process according to claim 41 wherein said oxidation catalyst is based on methyltrioxorhenium.

43. A process according to claim 42 wherein said solvent is selected from toluene, chloroform, and perfluorinated alcohols; and wherein said oxidation reaction conditions are sufficient to form both oxirane rings and dihydroxyl groups at the residual double bonds present within said terpolymer components.

44. A process according to claim 42 wherein said solvent is selected from toluene and chloroform, said oxidation reaction conditions include oxidation temperatures ranging from 50° C. to 100° C. and said oxidized terpolymer components are primarily hydroxylated.
